(19) United States
(12) Patent Application Publication
(10) Pub. No.: US 2006/0025206 A1
(43) Pub. Date: Feb. 2, 2006

(54) Gaming device operable to faciliate audio output via a headset and methods related thereto

(76) Inventors: Jay S. Walker, Ridgefield, CT (US); Robert C. Tedesco, Fairfield, CT (US); James A. Jorasch, New York, NY (US); Daniel E. Tedesco, Huntington, CT (US); Stephen C. Tulley, Monroe, CT (US); Magdalena M. Fincham, Ridgefield, CT (US)

Correspondence Address: WALKER DIGITAL, FIVE HIGH RIDGE PARK, STAMFORD, CT, 06905, US

(21) Appl. No.: 11/251,290

(22) Filed: Oct. 14, 2005

Related U.S. Application Data
(63) Continuation-in-part of application No. 10/655,154, filed on Sep. 4, 2003.
(63) Continuation-in-part of application No. 10/322,107, filed on Dec. 18, 2002.
Application No. 10/322,107 is a continuation of application No. 09/641,903, filed on Aug. 18, 2000, now Pat. No. 6,530,835.
Application No. 09/641,903 is a continuation of application No. 08/821,437, filed on Mar. 21, 1997, now Pat. No. 6,139,431.
(60) Provisional application No. 60/408,473, filed on Sep. 4, 2002.
(60) Provisional application No. 60/621,727, filed on Oct. 25, 2004.

(51) Int. Cl. A63F 13/00

(52) U.S. Cl. 463/20

(57) ABSTRACT

In accordance with one or more embodiments, a first audio or first type of audio is output via a first audio output element (e.g., a speaker) of a gaming device and a second audio or second type of audio is output via a second audio output element (e.g., a headset or ultrasonic speaker) of a gaming device. In one embodiment, the first type of audio is game related audio audible to general passersby of the gaming device while the second type of audio is only audible to a qualified player (e.g., a player utilizing the second audio output device, a player who has registered, paid and/or otherwise qualified for the second type of audio, a player associated with the second audio output device, etc) and is not audible to general passersby of the gaming device. The second type of audio may comprise, for example, hints or tips for playing a game, music, news, sportscasts, promotional offers, jokes and/or conversations with other persons (e.g., via a landline or cellular telephone connection).

This application claims the benefit of U.S. Provisional Application Ser. No. 60/621727, filed Oct. 25, 2004 and entitled GAMING DEVICE WITH HEADSET FEATURES. The entirety of this application is incorporated by reference herein for all purposes.

This application is also a continuation-in-part of U.S. application Ser. No. 10/655154, filed Sep. 4, 2003 and entitled METHOD AND APPARATUS FOR PROVIDING A COMPLIMENTARY SERVICE TO A PLAYER; which claims priority to Ser. No. 60/408473 filed Sep. 4 2002, entitled METHOD AND APPARATUS FOR PROVIDING A COMPLIMENTARY SERVICE TO A PLAYER; and is a CIP of Ser. No. 10/322107 filed Dec. 18, 2002, FREE LONG DISTANCE CALLS ON SLOT MACHINES; which is a CON of Ser. No. 09/641903 filed Aug. 18, 2000, FREE LONG DISTANCE CALLS ON SLOT MACHINES; which is a CON of Ser. No. 08/821437 filed Mar. 21, 1997, FREE LONG DISTANCE CALLS ON SLOT MACHINES.

### BRIEF DESCRIPTION OF THE FIGURES

Various embodiments of the present invention are described herein with reference to the accompanying drawings. In the drawings, like reference numerals indicate identical or functionally similar elements. The leftmost digit(s) of a reference numeral typically identifies the figure in which the reference numeral first appears. As will be understood by those skilled in the art, the drawings and accompanying descriptions presented herein indicate some exemplary arrangements for stored representations of information. A number of other arrangements may be employed besides the tables shown. Similarly, the illustrated entries represent exemplary information, but those skilled in the art will understand that the number and content of the entries can be different from those illustrated herein. A brief description of the drawings follows.

FIG. 1 is a flowchart depicting a process in accordance with at least one embodiment.

FIG. 2 is a block diagram of a system in accordance with at least one embodiment.

FIG. 3 is a block diagram of a controller in accordance with at least one embodiment.

FIG. 4 is a block diagram of a gaming device in accordance with at least one embodiment.

FIG. 5 is a plan view of an example gaming device comprising a slot machine, and a player utilizing the slot machine, in accordance with one or more embodiments.

FIG. 6 is an illustration of an example menu of available supplemental audio that may be output to a casino patron in accordance with one or more embodiments.

FIGS. 7A and 7B are a table illustrating an example structure and example data for a player database in accordance with at least one embodiment.

FIG. 8 is a table illustrating an example structure and example data for a headset database in accordance with at least one embodiment.

FIGS. 9A and 9B are a table illustrating an example structure and example data for a registered supplemental audio database in accordance with at least one embodiment.

FIG. 10 is a table illustrating an example structure and example data for a supplemental audio output rules database in accordance with at least one embodiment.

FIG. 11 is a table illustrating an exemplary structure and exemplary data for a supplemental audio trigger database in accordance with one or more embodiments.

FIG. 12 is a flowchart illustrating a process in accordance with one or more embodiments.

FIG. 13 is a flowchart illustrating a process in accordance with one or more embodiments.

FIG. 14 is flowchart illustrating a process in accordance with one or more embodiments.

### DETAILED DESCRIPTION

Numerous embodiments are described in this patent application, and are presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that structural, logical, software, electrical and other changes may be made without departing from the scope of the present invention. Accordingly, those skilled in the art will recognize that the present invention may be practiced with various modifications and alterations. Although particular features of the present invention may be described with reference to one or more particular embodiments or figures that form a part of the present disclosure, and in which are shown, by way of illustration, specific embodiments of the invention, it should be understood that such features are not limited to usage in the one or more particular embodiments or figures with reference to which they are described. The present disclosure is thus neither a literal description of all embodiments of the invention nor a listing of features of the invention that must be present in all embodiments.

The terms “an embodiment”, “embodiment”, “embodiments”, “the embodiment”, “the embodiments”, “an embodiment”, “some embodiments”, “an example embodiment”, “at least one embodiment”, “one or more embodiments” and “one embodiment” mean “one or more (but not necessarily all) embodiments of the present invention(s)” unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The terms “a”, “an” and “the” mean “one or more”, unless expressly specified otherwise.

The term “based on” means “based at least on”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, and 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device that accesses data in such a database.

In accordance with one or more embodiments, a first audio or first type of audio is output via a first audio output element (e.g., a speaker) of a gaming device and a second audio or second type of audio is output via a second audio output element (e.g., a headset or ultrasonic speaker) of a gaming device. In one embodiment, the first type of audio is game related audio audible to general passersby of the gaming device while the second type of audio is only audible to a qualified player (e.g., a player utilizing the second audio output device, a player who has registered, paid and/or otherwise qualified for the second type of audio, a player associated with the second audio output device, etc) and is not audible to general passersby of the gaming device. The second type of audio may comprise, for example, hints or tips for playing a game, music, news, sportscasts, promotional offers, jokes and/or conversations with other persons (e.g., via a landline or cellular telephone connection).

Outputting a first audio or first type of audio may comprise, for example, outputting a signal associated with a first audio file. Similarly, outputting a second audio or second type of audio may comprise, for example, outputting a signal associated with a second audio file. In some embodiments, outputting audio may comprise enabling access to a broadcast or stream of live audio, rather than enabling access to stored audio (e.g., an audio file).

In some embodiments the second audio or second type of audio that is output via a private audio channel is referred to herein as supplemental audio herein. Supplemental audio may comprise audio that is not necessarily directly related to play of a game and/or not necessary or preferred to aid in understanding or underscoring events in a game.

For example, Applicants have recognized that it may be advantageous in some circumstances to make certain audio or a certain type of audio only available via a private audio channel that is not audible to a general passerby of a gaming device. For example, it may be advantageous to output audio that a player pays to hear or otherwise has to qualify to hear via a private audio channel that is only audible to the player rather than via speakers the sound of which is audible to passersby of the gaming device. Such a type of audio may comprise, for example, tips, hints or strategies for playing a game, promotional offers, premium music or other audio information (e.g., news, sportscasts, etc).

It should be understood that, as used herein, audio not being audible to general passersby or persons other than a designated person includes the audio being barely, if at all, audible or audible only at a very low decibel level to the general passersby or persons other than a designated person. Similarly, it should be understood that a private audio channel includes any means by which audio may be output to a designated person such that the audio is audible at a reasonable, preferred, or relatively high decibel level by the designated person while being barely, if at all, audible or only audible at a relatively low decibel level to any person other than the designated person. In one or more embodiments, more than one individual may comprise a designated person.

Applicants have further recognized that in certain circumstances it may be advantageous to enable a player to hear certain audio without necessarily burdening nearby players with hearing the audio. For example, a first player may find it enjoyable to hear the news or sportscast while playing a gaming device, or to carry on a conversation with another player or friend. However, a second player who may be playing a gaming device next to the first players gaming device may find such audio distracting or otherwise not enjoyable. Accordingly, it would be advantageous to allow the first player to hear such audio without burdening the second player with hearing or over-hearing such audio or by minimizing the likelihood that the second player over-hear the audio selected by the first player. By allowing the first player access to such audio via a private audio channel such as a headset, a casino may satisfy the preferences of both players. Embodiments of the present invention allow a casino or other entity to cater to an audio preference of one player without burdening another player with the audio selected or being enjoyed by the first player.

Additionally, Applicants have recognized that it may be advantageous in certain circumstances for a gaming device outputting audio via a private channel to additionally output audio via a public channel. For example, while certain sounds may only be relevant to an individual player, and thus may be output via a private channel, other sounds may be relevant to passersby or others within proximity to a gaming device, and thus may be output via a public channel such as speakers (e.g., game sounds and celebratory payout sounds may be output via public speakers so as to preserve the familiar din of a casino floor, while still allowing private audio to be heard via private means such as a headset).

With these and other advantages and features of the invention that will become hereinafter apparent, the nature of the invention may be more clearly understood by reference to the following detailed description of the invention, to the appended claims and to the several drawings attached herein.

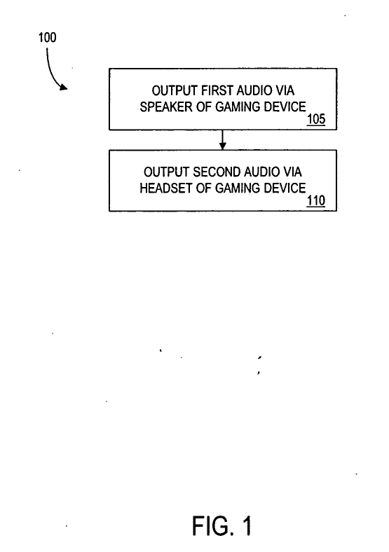

Referring now to FIG. 1, illustrated therein is a flowchart illustrating a process 100 in accordance with one or more embodiments of the present invention. The process 100 may be performed, for example, by a controller, gaming device, other device or combination thereof.

Referring now to step 105, a first audio (or first type of audio) is output via a speaker of a gaming device. A speaker is one example of a first audio output element of a gaming device that is operable to output sounds audible to general passersby of the gaming device (e.g., sounds to attract players to the gaming device, game-related sounds that aid in understanding or underscoring events occurring at the gaming device, etc.). A speaker may comprise, for example, one or more speakers built into a cabinet of the gaming device. Outputting the first audio (or first type of audio) via a speaker of a gaming device may comprise, for example, a processor utilizing a sound card of a gaming device to output a first audio file via a speaker of the gaming device or a processor utilizing a sound card to output a first signal associated with a first audio file via the speaker. Outputting the first audio (or first type of audio) may be performed, for example, in response to a player initiating a game play at the gaming device, in order to attract players to the gaming device while the gaming device is idle, and/or to inform a player of an error or other event at the gaming device.

It should be noted that many different sounds, types of sounds, audio files, portions of audio files and types of audio files may comprise the first audio or first type of audio. For example, a first sound, first audio file, first type of audio file, or first portion of an audio file may be output upon an occurrence of a first event at the gaming device (e.g., an error or payout occurring, a first game being played, a first event in a game occurring, an attract mode being active, etc.) while a second sound, second audio file, second type of audio file or second portion of an audio file may be output upon an occurrence of a second and distinct event at the gaming device. However, both sounds, audio files, types of audio file or portions of an audio file may be considered the first audio or type of audio (e.g., because both are output via the first audio output element of the gaming device that outputs sounds audible to general passersby of the gaming device).

Referring now to step 110, a second audio (or second type of audio) is output via a second audio output element of the gaming device. The second audio output element may be a private audio channel operable to output sounds such that the sounds are not audible to general passersby of the gaming device. The second audio output element may comprise, for example, a headset (as specified in the embodiment of process 100). Of course, different types of private audio channels may comprise the second audio output element of the gaming device. For example, a second audio output element may comprise an ultrasonic emission device such that sound may be directed at a specific location in an ultrasonic manner. Such an ultrasonic emission device may serve to deliver “private audio” to designated players (e.g., a player currently playing a gaming device). In one embodiment, such a device may be operable to output one or more types of supplemental audio (e.g., such that game-related sounds may be output via traditional speakers and hints may be output to a designated player via an ultrasonic emission device housed in the cabinet of a gaming device or otherwise associated with a gaming device). One example of such ultrasonic technology is described in U.S. Pat. No. 6,638,169 to Wilder et al., the entirety of which is incorporated herein by reference for all purposes.

Outputting the second audio (or second type of audio) via a second audio element of a gaming device (such as a headset or ultrasonic emission device) may comprise, for example, a processor utlizing a sound card of a gaming device to output a second audio file via the second audio output element or a processor utilizing a sound card to output a signal associated with a second audio file via the second audio output element. In some embodiments, in which at least some sounds output via the second audio output element are also output via the first audio output element, a gaming device may be operable to mix audio files or sounds from multiple audio files or sources. For example, in some embodiments game-related audio my be output via a first audio output element (e.g., speakers the sound of which is audible to general passersby of a gaming device) and output game-related audio as well as hints or another type of supplemental audio via a second audio output element that comprises a private audio channel (e.g., a headset). In such an embodiment, a gaming device may be operable to mix or otherwise combine sounds from a game-related audio file or other source with sounds from a hints audio file or other source for output via the second audio output element.

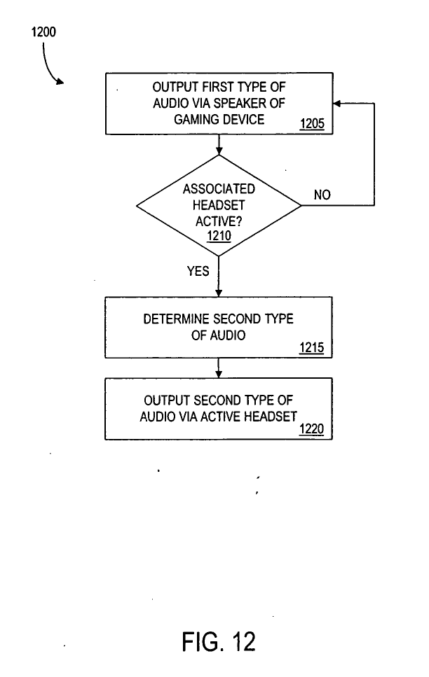

The second audio (or second type of audio) may be output in step 110 upon an occurrence of one or more events. For example, the second audio (or second type of audio) may be output in response to determining that a second audio output element of a gaming device is active (e.g., has been turned on or otherwise activated by a player). In such embodiments, process 100 may include additional steps, such as determining whether a second audio output element is active and/or receiving an indication that the second audio output element is active. Various method of determining whether an audio output element, such as a headset, is active are described in detail with respect to process 1200 (FIG. 12, below) and need not be repeated herein. Other events and/or determinations that may cause the second audio (or second type of audio) to be output in step 110 include, but are not limited to, (i) determining that a trigger associated with the second audio or second type of audio has occurred (e.g., a condition associated with the output of the second audio or second type of audio has been satisfied); (ii) determining that a player has requested and/or qualified for output of the second audio or second type of audio; and/or (iii) receiving a signal indicating that the second audio or second type of audio should be output (e.g., from a controller 205 and/or from a casino employee).

It should be noted that, in some embodiments, the first audio and the second audio may be of the same type. For example, both the first audio and the second audio may be game-related audio. However, in some embodiments in which the first audio and the second audio are of the same type, different sounds may be output and/or a set of sounds may be output via a first audio output element (e.g., a headset) while a subset of the sounds may be output via a second audio output element (e.g., speakers). For example, the sounds output via the headset may include additional premium sounds not output via the speakers. In some embodiments, the first audio output via a first audio output element (e.g., speakers) may be of a first type of audio while a second audio output via a second audio output element (e.g., a headset) may include audio of both the first type and audio of a second type. For example, game-related data may be output via speakers while both game related data and promotional offers may be output via a headset.

As described herein, in some embodiments in which two different types of audio are output via a private audio channel (e.g., via a headset), the output of one of the types of audio may interrupt the output of another one of the types of audio. For example, if both game-related data and hints are being output via a headset, the output of a hint may interrupt the output of the game-related data. In another example, if game-related data, hints and music are being output via a headset, the output of the music may be output substantially continuously but may be interrupted for output of a hint and/or output of game-related sounds that aid in understanding or underscoring an event in a game. Interrupting a first type of audio to output a second type of audio may comprise, for example, pausing the first type of audio, modifying (e.g., lowering) the volume level of the first type of audio and/or skipping a portion of the first type of audio. In one embodiment, all supplemental audio could be interrupted based on an event. For example, the supplemental audio may be paused or otherwise interrupted upon an occurrence of an event in a game (e.g., a top jackpot being won). In addition to interrupting the output of one audio or type of audio for output of another type of audio or type of audio, various other methods of mixing, intermingling, combining or otherwise enabling the output of two different audios or two different types of audio via a single audio output element during single play session would be understood by one of ordinary skill in the art upon reading the present disclosure. For example, a mixing circuit may be used in conjunction with a sound card having two audio output channels.

In some embodiments, a player may be required to first qualify to hear the second audio or second type of audio before the second audio or second type of audio is output via a private audio channel to the player. For example, the player may required to provide a payment for, register for and/or select the second audio and/or second type of audio. In another example, the player may be required to engage in a particular activity or type of activity (e.g., in a particular manner) in order to qualify for output of the second audio or second type of audio. The activity and/or type of activity may or may not be gambling related. In other embodiments, a second audio or second type of audio may be available for output to any and all players playing a gaming device operable to provide such audio, without requiring a player to qualify for output of such audio.

In a more particular example of engaging in a particular activity or type of activity, the player may be required to (i) play a gaming device at a particular or minimum rate of play, (ii) wager at a maximum or minimum allowable level, (iii) purchase a flat rate plat session (e.g., perhaps above a threshold price), (iv) play with a player tracking card inserted into a gaming device, and/or (v) employ a particular strategy when playing a gaming device. In another more particular example of engaging in a particular activity or type of activity, the player may be required to (i) fill out a form (e.g., electronic or paper form), (ii) answer one or more survey questions, (iii) listen to promotional offers, (iv) join a casino loyalty club, (v) register as a guest at a hotel affiliated with a particular casino, (vi) eat at a restaurant affiliated with a particular casino, (vii) complete a purchase at a merchant affiliated with a particular casino; and/or (viii) achieve a particular status as a member of a casino loyalty club (e.g., frequent player, whale, etc.).

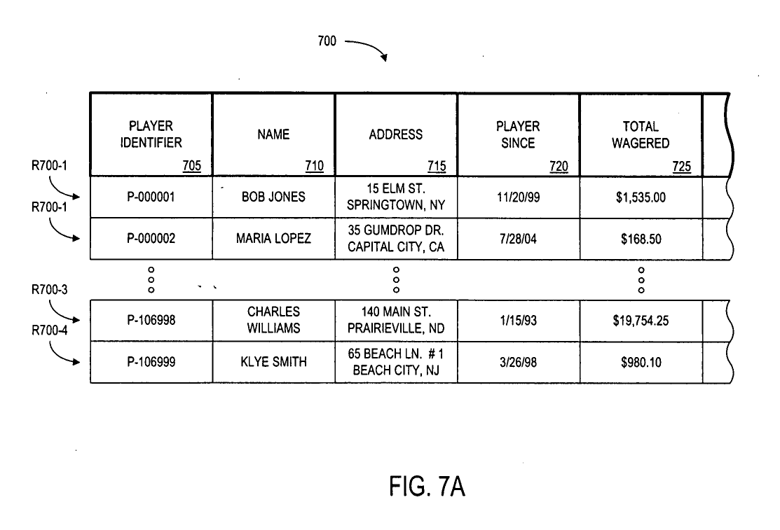

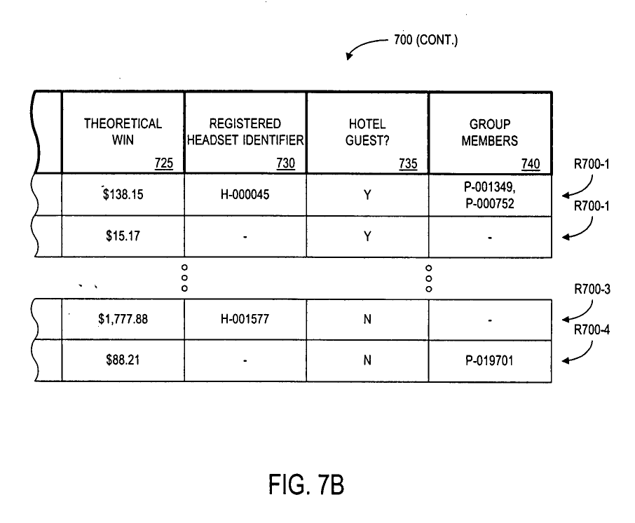

Accordingly, in some embodiments process 100 may further include a step of determining whether a player has qualified (and/or continues to qualify) for output of supplemental audio in general and/or for output of one or more particular types of supplemental audio. For example, using one or more of the databases described with respect to FIGS. 7A through 11 (each of which is described in detail below), it may be determined whether a player has registered for a particular type of supplemental audio, has paid for output of a particular type of supplemental audio and/or has satisfied a condition for outputting a particular type of supplemental audio.

In some embodiments, a player may be charged for output of supplemental audio upon the player having ended the output of the supplemental audio. In such embodiments, process 100 may further include tracking a duration of time for which supplemental audio was output to the player and/or an amount of supplemental audio output to the player (e.g., a number of hints output to the player, a number of songs listened to by the player, a number of minutes a player engaged in a telephone conversation via a headset, a number of minutes a player listened to a newscast, etc,). The process 100 may further include transmitting such information to another device (e.g., controller 205), determining an appropriate price to charge the player for the output of the supplemental audio, and/or causing an appropriate payment to be collected from the player. For example, a gaming device 210 and/or a controller 205 may calculate the appropriate price to charge the player. A gaming device 210 and/or a controller 205 may then cause payment to be collected from the player in one or more of a variety of manners. For example, a financial account the identifier of which was previously provided by the player may be charged for the price. In another example, the price may be displayed to the player and the player may be allowed to provide an appropriate payment via the gaming device. For example, the player may insert currency and/or authorize an appropriate amount of credits to be deducted from the credit meter balance of the gaming device.

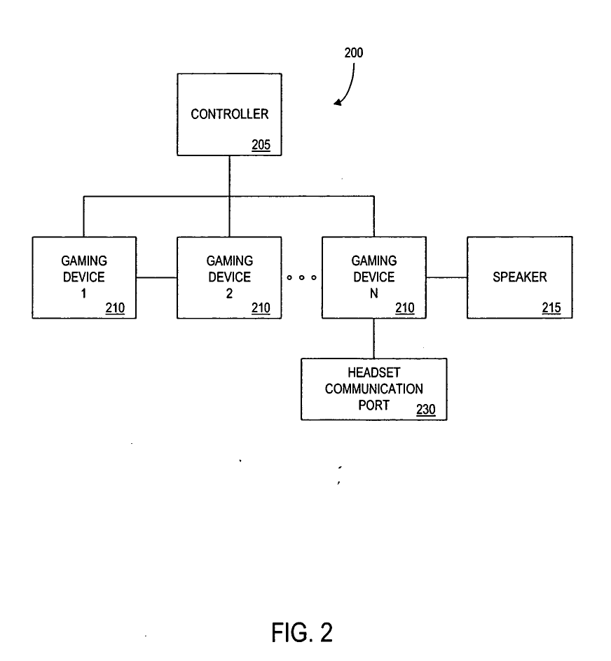

Referring now to FIG. 2, an example embodiment 200 of a system in accordance with one or more embodiments is depicted in block diagram form. Embodiment 200 is referred to as system 200 herein. The present invention can be configured to work as a system 200 in a network environment including a controller 205 (e.g., a slot server of a casino) that is in communication, via a communications network, with one or more gaming devices 210 (e.g., slot machines, video poker machines, etc.). The controller 205 may communicate with any and all of the gaming devices 210 directly or indirectly, via a wired or wireless medium such as the Internet, LAN, WAN or Ethernet, Token Ring, or via any appropriate communications means or combination of communications means. Each of the gaming devices 210 may comprise computers, such as those based on the Intel® Pentium® processor, that are adapted to communicate with the controller 205. Any number, type and/or number of types of gaming devices 210 may be in communication with the controller 205.

As illustrated via system 200, in one or more embodiments a gaming device 210 may comprise a speaker 215 and a headset communication port 230. For example, a gaming device in accordance with one or more embodiments may be operable to accept a headset into a headset communication port 230 and, upon detecting that a headset has been connected to the gaming device via headset communication port 230, output a second type of audio via the headset while outputting a first type of audio via the speaker 215. The speaker 215 may, in some embodiments, comprise a public audio channel the sounds of which are audible to general passersby of the gaming device while the headset and headset communication port 230 may comprise a private audio channel the sounds of which are only audible to a person wearing the headset. As described herein, in some embodiments audio may only be output via the headset communication port 230 if a gaming device, headset connected to the gaming device via the headset communication port 230 and /or player currently playing the gaming device qualifies for the audio.

Communication between the gaming devices 210 and the controller 205 and/or among the gaming devices 210 may be direct or indirect, such as over the Internet through a Web site maintained by computer on a remote server or over an on-line data network including commercial on-line service providers, bullein board systems and the like. In yet other embodiments, the gaming devices 210 may communicate with one another and/or the controller 205 over RF, cable TV, satellite links and the like.

Some, but not all, possible communication networks that may comprise the network or be otherwise part of the system 200 include: a local area network (LAN), a wide area network (WAN), the Internet, a telephone line, a cable line, a radio channel, an optical communications line, and a satellite communications link. Possible communications protocols that may be part of the system include: Ethernet (or IEEE 802.3), SAP, ATP, Bluetooth™, and TCP/IP. Communication may be encrypted to ensure privacy and prevent fraud in any of a variety of ways well known in the art.

A variety of communications protocols may be part of the system 260 or another system operable to facilitate the embodiments described herein, including but not limited to: Ethernet (or IEEE 802.3), SAP, SAS™, SuperSAS™, ATP, Bluetooth™, and TCP/IP. Further, in some embodiments, various communications protocols endorsed by the Gaming Standards Association of Fremont, Calif., may be utilized, such as (i) the Gaming Device Standard (GDS), which may facilitate communication between a gaming device and various component devices and/or peripheral devices (e.g., printers, bill acceptors, etc.), (ii) the Best of Breed (BOB) standard, which may facilitate communication between a gaming device and various servers related to play of one or more gaming devices (e.g., servers that assist in providing accounting, player tracking, content management, ticket-in/ticket-out and progressive jackpot functionality), and/or (iii) the System-to-System (S2S) standard, which may facilitate communication between game-related servers and/or casino property management servers (e.g., a hotel server comprising one or more databases that store information about booking and reservations). Communication may be encrypted to ensure privacy and prevent fraud in any of a variety of ways well known in the art.

In some embodiments, a controller 205 may not be necessary and/or preferred. For example, one or more embodiments may be practiced on a stand-alone gaming device 210 and/or a gaming device 210 in communication only with one or more other gaming devices 210 (i.e. without a controller 205). In such embodiments, any functions described as performed by the controller 205 or data described as stored on the controller 205 may instead be performed by or stored on one or more gaming devices 210.

In one or more embodiments, system 200 may include additional devices, such as one or more casino personnel devices, one or more additional servers (e.g., a hotel reservation server, a headset registration server, a supplemental audio server and/or an inventory management server). In accordance with one embodiment, a headset registration server may comprise, for example, a server storing information regarding which players have registered to use headsets to receive audio via the headsets. Of course, such information may also be stored at controller 205, as described herein. In accordance with one embodiment, a supplemental audio server may comprise, for example, a server storing information regarding players who have registered to receive supplemental audio via a private audio channel (e.g., a headset). Of course, such information may also be stored at controller 205, as described herein. One or more point-of-sale terminals associated with one or more merchants may also be included in system 200.

In some embodiments, various casino employees may be equipped with or otherwise utilize one or more casino personnel devices, such as personal digital assistants (PDAs) or other computing devices (e.g., personal computer terminals). A casino personnel device may comprise various input devices (e.g., a keypad, a touch-sensitive display screen, a card reader, an infrared bar code scanner, etc.), various output devices (e.g., an LCD screen), a processor, a memory and/or a communications port, as described herein with respect to other devices. In some embodiments, a casino personnel device may communicate with a gaming device, server, kiosk, peripheral device, and/or an inventory/reservation system of a casino-maintained property (e.g., a hotel). Thus, a casino personnel device may be configurable to, among other things, (i) read from and/or write to one or more databases of the present invention, (ii) assist in payments made to players (e.g., a representative “scans” a cashless gaming receipt and determines a value associated with the receipt, and if the receipt is valid, provides payment equal to the value), (iii) assist in payment made by players (e.g., a casino representative may receive a payment from a player for supplemental audio the player desires to gain access to or that the player has received access to and owes payment for); (iv) assist in registering players for a headset and/or for receiving supplemental audio; and/or (iii) execute or assist in the execution of various other processes described herein. For example, a casino employee may utilize a casino personnel device to (i) obtain, display and/or view information about available supplemental audio, (ii) register the player for the supplemental audio, and/or (iii) receive a payment or means of payment (e.g., a credit or debit card number) from a player in exchange for supplemental audio the player desires to gain access to in the future or supplemental audio that the player has gained access to in the past and owed payment for. In one or more embodiments, a casino personnel device may be operable to read data from and/or write data to one or more of the databases described herein. A memory of a casino personnel device may store a program for executing processes described herein, or portions thereof.

In some embodiments, various merchants (e.g., shops, restaurants, etc.) may utilize point-of-sale (POS) computer terminals to facilitate various processes of the present invention. For example, in some embodiments, a player may win, earn or otherwise qualify to receive supplemental audio at a gaming device via a private audio channel by making purchases at a merchant. In another example, a player may register at a merchant to gain access to supplemental audio and/or rent or purchase a headset for use in receiving supplemental audio at a gaming device. Thus, in some embodiments, merchants may utilize POS terminals to (i) determine a player's eligibility to receive supplemental audio; (ii) transmit a player's eligibility to receive supplemental audio; (iii) register a player to receive supplemental audio; (iv) receive a payment from a player for supplemental audio; and/or (v) sell or rent a headset to a player (and, for example, transmit an indication of the rental or sale to controller 205).

In some embodiments, POS terminals may be configured to read from and/or write to one or more databases of the present invention. Such POS terminals may thus comprise various hardware and software described herein with respect to other devices, and may communicate with (i) a casino server, (ii) a gaming device, (iii) an inventory/reservation system (e.g., a computer terminal at a theatre communicates with an inventory database to determine a number of unsold seats for a certain event), and so on.

In some embodiments of the present invention, various component devices (e.g., any or all of the benefit output devices, output devices, input devices and/or input output devices described herein) may be embodied as peripheral devices. For example, such devices may not necessarily be components of a gaming device, though they may be configured in such a manner so as to communicate with one or more gaming device processors or any other devices described herein. For example, a peripheral device such as a large display device may be associated with a plurality of gaming devices, and thus may not necessarily be considered a component of any one gaming device. Further, in some embodiments, certain peripheral devices such as card readers may be interchangeable between gaming devices, and thus may be considered a component of a first gaming device while connected thereto, removed from the first gaming device, connected to a second gaming device, and so on. In other embodiments, various peripheral devices may never be considered a component of a particular gaming device. For example, in some embodiments, a peripheral device such as a USB-based portable memory device may store (i) one or more databases described herein, and/or (ii) a program for executing one or more process steps described herein. Such a peripheral device may then be utilized by casino personnel for upgrading/retrofitting existing gaming devices as described herein.

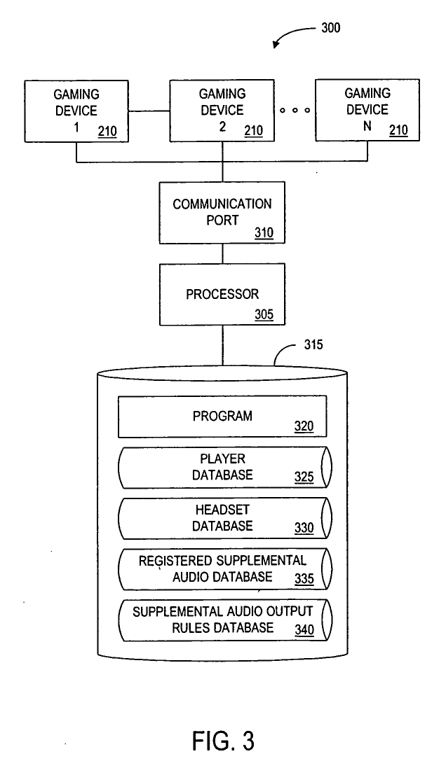

Referring now to FIG. 3, illustrated therein is an embodiment 300 of a controller operable to communicate with at least one gaming device. The embodiment 300 may be, for example, an embodiment of the controller 205. Embodiment 300 is referred to as controller 300 herein. The controller 300 may be implemented as a system controller, a dedicated hardware circuit, an appropriately programmed general-purpose computer, or any other equivalent electronic, mechanical or electro-mechanical device. The controller 300 may comprise, for example, a server computer operable to communicate with one or more client devices, such as one or more gaming devices, one or more kiosks, one or more peripheral devices, and/or one or more casino personnel devices. The controller 300 may be operative to manage the system 100 execute some or all of the methods described herein.

In operation, the controller 300 may function under the control of a casino, another merchant, or other entity that may also control use of the gaming devices 210. For example, the controller 300 may be a slot server in a casino. In some embodiments, the controller 300 and a slot server may be different devices. In some embodiments, the controller 300 may comprise a plurality of computers operating together. In some embodiments, the controller 300 and a gaming device may be the same device.

The controller 300 comprises a processor 305, such as one or more Intel® Pentium® processors. The processor 305 is in communication with a communication port 310 (e.g., for communicating with one or more other devices, such as one or more gaming devices 210) and a memory 315. The memory 315 may comprise an appropriate combination of magnetic, optical and/or semiconductor memory, and may include, for example, Random Access Memory (RAM), Read-Only Memory (ROM), a compact disc and/or a hard disk. The processor 305 and the memory 315 may each be, for example: (i) located entirely within a single computer or other device; or (ii) connected to each other by a remote communication medium, such as a serial port cable, telephone line or radio frequency transceiver. In one embodiment, the controller 300 may comprise one or more devices that are connected to a remote server computer for maintaining databases.

The memory 315 stores a program 320 for controlling the processor 305. The processor 305 performs instructions of the program 320, and thereby operates in accordance with the present invention, and particularly in accordance with the methods described in detail herein. The program 320 may be stored in a compressed, uncompiled and/or encrypted format. The program 320 furthermore includes program elements that may be necessary, such as an operating system, a database management system and “device drivers” for allowing the processor 305 to interface with computer peripheral devices. Appropriate program elements are known to those skilled in the art, and need not be described in detail herein. The program 320 may include computer program code that allows the controller 300 to employ the communication port 310 to communicate with a gaming device (e.g., gaming device 400, described below) in order to, for example:
1. track gambling activity performed at the gaming device;
2. track gaming activities of individual players;
3. track gaming session activities at the gaming device;
4. determine whether a headset has been activated at a gaming device;
5. determine whether a player, headset and /or gaming device qualifies for output of audio via a headset associated with a gaming device;
6. determine whether a player has registered a headset for use at a gaming device;
7. instruct a gaming device to perform one or more functions (e.g., output a specific audio or type of audio via a headset, activate a headset, initialize a particular game, etc.);
8. determine whether a player has provided a selection of audio or type of audio;
9. determine whether a player has provided a payment in exchange for output of audio via a headset; and/or
10. manage play or other operation of the gaming device.

According to an embodiment, the instructions of the program 320 may be read into a main memory from another computer-readable medium, such from a ROM to RAM. Execution of sequences of the instructions in program 320 causes processor 305 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

The memory 315 also stores (i) a player database 325; (ii) a headset database 330; (iii) a registered supplemental audio database 335; and (iv) a supplemental audio output rules database 340. Each of the databases 325 through 340 are described in more detail below.

In some embodiments (e.g., in an embodiment in which controller 300 manages downloadable games playable on one or more gaming devices 210), the memory 310 may store additional databases. Examples of such additional databases include, but are not limited to, (i) a gaming device database that stores information related to one or more gaming devices with which the controller 300 is operable to communicate, (ii) a game database that stores information regarding one or more games playable on and/or downloadable to one or more gaming devices 210, and (iii) a scheduling and/or configuration database useful for determining which games are to be made available on which gaming devices.

Similarly, in one embodiment controller 300 may be operable to configure a gaming device 210 remotely, update software stored on a gaming device 210 and/or to download software or software components to a gaming device 210. For example, controller 200 may be operable to apply a hot fix to software stored on a gaming device 210, modify a payout and/or probability table stored on a gaming device 210 and/or transmit a new version of software and/or a software component to a gaming device 210. Controller 300 may be programmed to perform any or all of the above functions based on, for example, an occurrence of an event (e.g., a scheduled event), receiving an indication from a qualified casino employee and/or other person (e.g., a regulator) and/or receiving a request from a player.

Although the databases 225 through 240 are described as being stored in a memory of controller 300, in other embodiments some or all of these databases may be partially or wholly stored, in lieu of or in addition to being stored in a memory of controller 300, in a memory of one or more other devices. Such one or more other devices may comprise, for example, one or more peripheral devices, one or more gaming devices, a slot server (if different from the controller 300), another device, or a combination thereof. Further, some or all of the data described as being stored in the memory 315 may be partially or wholly stored (in addition to or in lieu of being stored in the memory 315) in a memory of one or more other devices. Such one or more other devices may comprise, for example, one or more peripheral devices, one or more gaming devices, a slot server (if different from controller 300), another device, or a combination thereof.

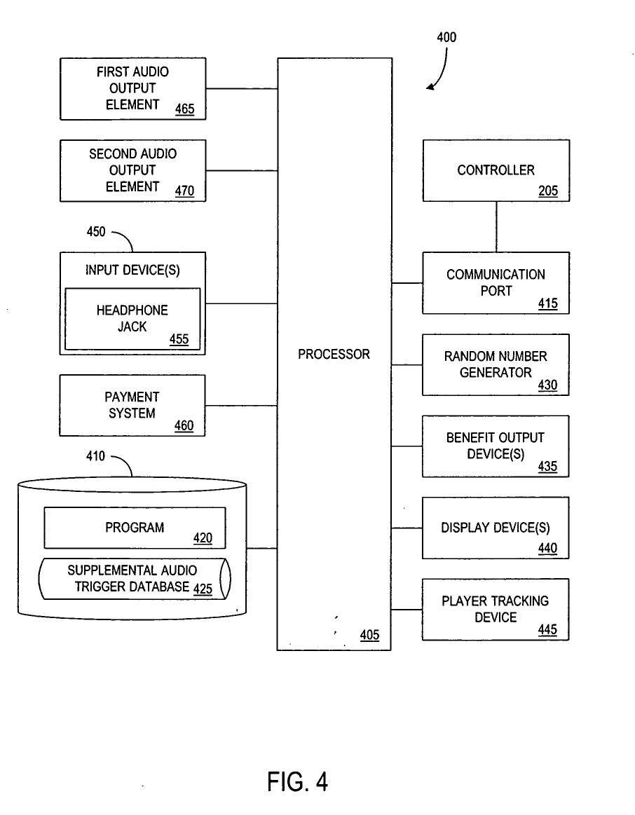

Referring now to FIG. 4, illustrated therein is a block diagram of an example embodiment 400 of a gaming device (e.g., a gaming device 210) that may be used in accordance with one or more embodiments. Embodiment 400 is referred to herein as gaming device 400.

The gaming device 400 may be implemented as a system controller, a dedicated hardware circuit, an appropriately programmed general-purpose computer, or any other equivalent electronic, mechanical or electromechanical device. The gaming device 400 may comprise, for example, a slot machine, a video poker terminal, a video blackjack terminal, a video keno terminal, a video lottery terminal, a pachinko machine or a table-top game (e.g., a mechanical or electromechanical device may be associated with a table game and be operable by a player and/or a dealer).

In some embodiments, a gaming device 400 may comprise, for example, a personal computer (e.g., which may communicate with an online casino Web site), a telephone (e.g., to communicate with an automated sports book that provides gaming services), and/or a portable handheld gaming device (e.g., a personal digital assistant, Nintendo GameBoy or Sony PSP, a dedicated personal hand-held gaming device provided by a casino, or any combination thereof). In some embodiments, a user device such as a PDA or cell phone may be used in place of, or in addition to, some or all of the gaming device 400 components depicted in FIG. 4. Further, a gaming device 400 may comprise a personal computer or other device operable to communicate with an online casino and facilitate game play at the online casino. In one or more embodiments, the gaming device 400 may comprise a computing device operable to execute software that simulates play of, for example, a reeled (mechanical or video) slot machine game, video poker game, video blackjack game, video keno game, video roulette game, or lottery game. In another embodiment, a gaming device 400 may comprise a hand-held device operable to display the results of a table game, slot machine game, keno game or other game being executed on a casino floor.

It should be noted that not all of the components described herein as being components of gaming device 400 may be necessary and/or preferred for a gaming device operable to implement embodiments described herein. For example, in embodiments in which a gaming device comprises a personal computer operable to access an online casino, a random number generator may not be a component of the gaming device but may rather be a component of a server administering the online casino. In another example, a gaming device that comprises a personal computer may not necessarily include a benefit output device and/or a player-tracking device.

In one embodiment, gaming device 400 may be operable to facilitate downloadable games such that games available for play on gaming device 400 may be stored on a server device (e.g., controller 205 or another dedicated device) and downloaded to the gaming device 400. In one embodiment, software components of the gaming device 400 may be remotely modified and/or updated by another device (e.g., controller 205 or another device). For example, a payout or probability table stored in the memory of gaming device 400 may be altered, modified or updated remotely, hot fixes may be applied to software stored by the gaming device 400 and/or new versions of software may be downloaded to the gaming device 400. Similarly, the gaming device 400 may be programmed to retrieve any or all such updates from another device, as appropriate and preferred. Any of the above (e.g., downloading of a game, updating of software, modification of a payout or probability table) may occur, for example, based upon an occurrence of an event (e.g., a scheduled event), an indication being received from qualified casino personnel or other personnel (e.g., a regulator), and/or upon a request from a player. In one embodiment, gaming device 400 may comprise a thin client device controlled be a server device (e.g., controller 205 or another dedicated device).

The gaming device 400 comprises a processor 405, such as one or more Intel® Pentium® processors. The processor 405 is in communication with a memory 410 and a communications port 415 (e.g., for communicating with one or more other devices, such as controller 205). The memory 410 may comprise an appropriate combination of magnetic, optical and/or semiconductor memory, and may include, for example, Random Access Memory (RAM), Read-Only Memory (ROM), a compact disc and/or a hard disk. The memory 410 may comprise or include any type of computer-readable medium. The processor 405 and the memory 410 may each be, for example: (i) located entirely within a single computer or other device; or (ii) connected to each other by a remote communication medium, such as a serial port cable, telephone line or radio frequency transceiver. In one embodiment, the gaming device 400 may comprise one or more devices that are connected to a remote server computer for maintaining databases.

The memory 410 stores a program 420 for controlling the processor 405. The processor 405 performs instructions of the program 420, and thereby operates in accordance with embodiments of the present invention, and particularly in accordance with the methods described in detail herein. The program 420 may be stored in a compressed, uncompiled and/or encrypted format. The program 420 may furthermore includes program elements that may be necessary, such as an operating system, a database management system and “device drivers” for allowing the processor 405 to interface with computer peripheral devices. Appropriate program elements are known to those skilled in the art, and need not be described in detail herein.

According to an embodiment described herein, the instructions of the program 420 may be read into a main memory from another computer-readable medium, such as from a ROM to RAM. Execution of sequences of the instructions in program 420 causes processor 405 to perform the process steps described herein. In some embodiments, hard-wired circuitry may be used in place of, or in combination with, software instructions for implementation of the processes of the present invention. Thus, embodiments described herein are not limited to any specific combination of hardware and software.

The memory 410 also stores a plurality of databases, including a supplemental audio trigger database 425. An audio trigger database may be stored in the memory 410 in tabular form, or any other appropriate database form, as is well known in the art. The data stored therein may include a number of exemplary records or entries, each defining a random number. Those skilled in the art will understand that the audio trigger database may include any number of entries. The tabular representation may also define fields for each of the entries or records.

In one or more embodiments, the gaming device 400 may store one or more additional databases. For example, gaming device 400 may store a probability database and/or a payout database. The fields of a probability database may specify, for example: (i) a random number (or range of random numbers) that may be generated by a random number generator; and (ii) an outcome that indicates the one or more indicia comprising the outcome that corresponds to the random number of a particular record. A gaming device 400 may utilize a probability database to determine, for example, what outcome corresponds to a random number generated by a random number generator and to display the determined outcome. The outcomes may comprise the three symbols to be displayed along the payline of a three-reel slot machine. Other arrangements of probability databases are possible. For example, the book “Winning At Slot Machines” by Jim Regan (Carol Publishing Group Edition, 1997) illustrates examples of payout and probability tables and how they may be derived. The entirety of this book is incorporated by reference herein for all purposes.

The fields of a payout database may specify, for example: (i) an outcome, which indicates the one or more indicia comprising a given outcome; and (ii) a payout that corresponds to each respective outcome. If gaming device 400 comprises a three-reel slot machine, for example, the outcomes may be those obtained on a three-reel slot machine.

A gaming device 400 may utilize a payout database to determine whether a payout should be output to a player as a result of an outcome obtained for a game. For example, after determining the outcome to output on the gaming device, the gaming device may access the payout database to determine whether the outcome for output is one of the outcomes stored as corresponding to a payout. If it is, the gaming device may provide the corresponding payout to the player via a benefit output device described herein. Other arrangements of payout databases are possible. For example, the book “Winning At Slot Machines” by Jim Regan (Carol Publishing Group Edition, 1997), previously incorporated by reference, illustrates many examples of payout and probability tables and how they may be derived.

Additionally, the memory 410 may store (e.g., while a headset or other private audio channel is active and being used to output audio), information associated with the audio and/or the private audio channel. For example, the memory 410 may store an indication of a type of audio preferred by a player currently playing the gaming device 400, an identifier of a headset that comprises the private audio channel, a payout provided or to be provided by the player for use of the private audio channel and/or an audio file of the audio being output or that may be output via the private audio channel. The memory 410 may store any and all such information, via, for example, a memory caching or disk caching mechanism.

Although database 425 is described as being stored in a gaming device 400, in other embodiments of the present invention this database (as well as any other database described as being stored in memory 410) may be partially or wholly stored (in addition to or in lieu of being stored in gaming device 400) in one or more other devices. Such one or more other devices may comprise, for example, (i) one or more peripheral devices, (ii) a peripheral device server, (iii) controller 205, (iv) another device, or (v) a combination thereof. Further, some or all of the data described as being stored in the database 425 and/or in memory 410 may be partially or wholly stored (in addition to or in lieu of being stored in the gaming device 400) in a memory of one or more other devices. Such one or more other devices may comprise, for example, (i) one or more peripheral devices, (ii) a peripheral device server, (iii) controller 205, (iv) another device, or (v) a combination thereof.

In one or more embodiments, as described, data may be stored in a memory of another device (e.g., a database of controller 205 or a database of another server device). In one or more embodiments, gaming device 400 may be operable to access the data thereof or have information associated with the data stored therein downloaded to the gaming device as necessary and/or appropriate. For example, gaming device 400 may access a memory of another device to determine a type of audio a player has indicated a preference for, an identifier of a headset a player has registered to use, and/or a payment or payment identifier a player has provided as a means of payment for supplemental audio and/or use of a private audio channel.

The processor 405 is also operable to communicate with a random number generator 430, which may be a component of gaming device 400. The random number generator 430, in accordance with at least one embodiment of the present invention, may generate data representing random or pseudo-random values (referred to as “random numbers” herein). The random number generator may generate a random number every predetermined unit of time (e.g., every second) and/or in response to an event such as an initiation of a game play on the gaming device or receipt of a signal from another device. In the former embodiment, the generated random numbers may be used as they are generated (e.g., the random number generated at substantially the time of game play initiation is used for that game play) and/or stored for future use. A random number generated by the random number generator may be used by the processor 405 to determine, for example, an outcome for a game play, a payout associated with an outcome, and/or which of a plurality of payouts to provide as the result of an outcome.

A random number generator, as used herein, may be embodied as a processor separate from but working in cooperation with processor 405. Alternatively, a random number generator may be embodied as an algorithm, program component, or software stored in the memory of gaming device 400 and used to generate a random number.

Note that, although the generation or obtainment of a random number is described herein as involving a random number generator of a gaming device, other methods of determining a random number may be employed. For example, a gaming device owner or operator may obtain sets of random numbers that have been generated by another entity. HotBits™, for example, is a service that provides random numbers that have been generated by timing successive pairs of radioactive decays detected by a Geiger-Muller tube interfaced to a computer. In another example, a blower mechanism that uses physical balls with numbers thereon may be used to determine a random number by randomly selecting one of the balls and determining the number thereof.

In yet another example, another device remote from and/or distinct from the gaming device 400 (e.g., a controller 205) may include a random number generator that generates random numbers to be provided to the gaming device 400. For example, in some embodiments, a gaming device may receive random numbers and/or any other data related to the random or pseudo-random determination of an outcome from a separate device, such as a server. It should be noted that such embodiments may be advantageous in environments or jurisdictions wherein the “central determination” of outcomes is required by regulation or otherwise preferred. Thus, for example, outcomes may be determined centrally by a server, and then propagated (e.g., electronically) such that indications of the outcomes may be viewed using one or more gaming devices (e.g., “Class II” gaming devices, thin client devices of a central-determination “Class III” gaming network, Video Lottery Terminals, and so on).

The processor 405 is also operable to communicate with one or more benefit output device(s) 435, which may be a component of gaming device 300. The benefit output device(s) 435 may comprise one or more devices for outputting a benefit (e.g., a payout, primary audio, supplemental audio, etc.) to a player of the gaming device 400.

For example, in one embodiment the gaming device 400 may provide coins and/or tokens as a benefit. In such an embodiment the benefit output device(s) 435 may comprise a hopper and hopper controller, for dispensing coins and/or tokens into a coin tray of the gaming device 400.

In another example, the gaming device 400 may provide a receipt or other document on which there is printed an indication of a benefit. For example, the gaming device may be operable to output one or more cash-out tickets. In such an embodiment the benefit output device(s) 435 may comprise a printing mechanism and a document dispensing mechanism.

In yet another example, the gaming device 400 may provide electronic credits as a benefit (which, e.g., may be subsequently converted to coins and/or tokens and dispensed from a hopper into a coin tray). In such an embodiment the benefit output device(s) 435 may comprise a credit meter balance and/or a processor that manages the amount of electronic credits that is indicated on a display of a credit meter balance. The processor may be the processor 405 or another processor.

In yet another example, the gaming device 400 may credit a monetary amount to a financial account associated with a player as a benefit provided to a player. The financial account may be, for example, a credit card account, a debit account, a charge account, a checking account, or a casino account. In such an embodiment the benefit output device(s) 435 may comprise a device for communicating with a server on which the financial account is maintained.

Note that, in one or more embodiments, the gaming device 400 may include more than one benefit output device or more than one type of benefit output device. For example, the gaming device 400 may include each of (i) a hopper and hopper controller combination, (ii) a credit meter balance, (iii) a document printing and dispensing combination, and (iv) a private audio channel such as a headset via which supplemental audio may be output. Such a gaming device may be operable to provide more than one type of benefit to a player of the gaming device.

A single benefit output device 435 may be operable to output more than one type of benefit. For example, a benefit output device 435 may be operable to increase the balance of credits in a credit meter and communicate with a remote device in order to increase the balance of a financial account associated with a player.

The processor 405 is also operable to communicate with one or more display device(s) 440, which may be a component of gaming device 400. The display device(s) 440 may comprise, for example, one or more display screens or areas for outputting information related to game play on the gaming device, such as a cathode ray tube (CRT) monitor, liquid crystal display (LCD) screen, or light emitting diode (LED) screen.

In one or more embodiments, gaming device 400 may comprise more than one display device. For example, gaming device 400 may comprise an LCD display for displaying electronic reels, a display area that displays rotating mechanical reels, and an LED display of a player tracking device (e.g., such as player tracking device 445, described below) that outputs information to a player.

The processor 405 may also be in communication with one or more other output devices besides the display device(s) 445, for outputting information (e.g., to a player or another device). Such other one or more output devices may also be components of gaming device 400. Such other one or more output devices may comprise, for example, an audio speaker (e.g., for outputting audio information corresponding to audio/video content), a headset or other private audio channel (e.g., for outputting supplemental audio to a player), an infra-red transmitter, a radio transmitter, an electric motor, a printer (e.g., such as for printing cashless gaming vouchers), a ticket or product dispenser, an infra-red port (e.g., for communicating with a second gaming device or a portable device of a player), a Braille computer monitor, and a coin or bill dispenser. For gaming devices, common output devices include a cathode ray tube (CRT) monitor on a video poker machine, a bell on a gaming device (e.g., rings when a player wins), an LED display of a player's credit balance on a gaming device, an LCD display of a personal digital assistant (PDA) for displaying keno numbers.

The display device(s) 440 may comprise, for example, one or more display areas. For example, one of the display areas may display outcomes of games played on the gaming device (e.g., electronic reels of a gaming device). Another of the display areas may display rules for playing a game of the gaming device. Yet another of the display areas may display the benefits obtainable by playing a game of the gaming device (e.g., in the form of one or more payout tables). Yet another of the display areas may display supplemental audio available for selection (e.g., various private audio channels and the type of audio available for each).

In one or more embodiments, the gaming device 400 may include more than one display device, one or more other output devices, or a combination thereof (e.g., two display devices, two audio speakers and a headset). In one embodiment, a first display area and a second display area may comprise two distinct areas of the same display device (e.g., a slit screen or a window within a screen, etc.).

The processor 405 is also in communication with an input device 450, which may be a device that is capable of receiving an input (e.g., from a player or another device, such as a selection of an option or feature available on the gaming device, such as a selection of a type of supplemental audio) and which may be a component of gaming device 400. An input device may communicate with or be part of another device (e.g. a controller 205, another gaming device, etc.). For example, a player may use a touch screen to indicate his desire to view types of supplemental audio available (e.g., for purchase) and/or to view a status of a payment or payment identifier previously provided by the player (e.g., as a means of payment for the use of a private audio channel and/or in exchange for access to supplemental audio).

One particular type of input device illustrated in FIG. 4 is a headphone jack 455. A headset wire may be inserted into the headphone jack 455, for example, by a player desirous of hearing supplemental audio. In one embodiment, a gaming device 400 may be programmed to determine whether a headset has been activated by determining whether a headset wire has been inserted into the headphone jack 455. Further, in one embodiment, a gaming device 400 may be programmed to output supplemental audio once it is determined that a headset is active. As commercially-available headsets commonly interface with other devices by means of a variety of connection types, it is contemplated that headset jack 455 may take many forms, including but not limited to an ⅛″ or ¼″ diameter stereo or mono audio input jack, a USB port, a wireless receiver unit, and so on. Further, as would be understood by one of ordinary skill in the art, more than one headphone jack 455 may be utilized (e.g., per gaming device).

Some other examples of input devices include: a bar-code scanner, an optical scanner configured to read other indicia of a voucher or cashless gaming ticket, a CCD camera, a magnetic stripe reader (e.g., for reading data encoded upon a player tracking card), a smart card reader (e.g., for reading data stored upon a smart card), a computer keyboard or keypad, a button, a handle, a lever, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port (e.g., for receiving communications from a second gaming device or from a another device such as a smart card or PDA of a player), and a weight scale. For gaming devices, common input devices include a button or touch screen on a video poker machine, a lever or handle connected to the gaming device, a magnetic stripe reader to read a player tracking card and/or contract card inserted into a gaming device, a touch screen for input of player selections during game play, a paper ticket acceptor for accepting paper tickets such as cash-out tickets and a coin and bill acceptor.

In some embodiments, a gaming device may comprise components capable of facilitating both input and output functions (i.e., input/output devices). In one example, a touch-sensitive display screen comprises an input/output device (e.g., the device outputs graphics and receives selections from players). In another example, a processor may communicate with a “ticket-in/ticket-out” device configured to dispense and receive cash-out tickets. Such a device may also assist in (e.g., provide data so as to facilitate) various accounting functions (e.g., ticket validation and redemption). For example, any or all of a gaming device, kiosk and casino personnel device maintained at a cashier cage may (i) comprise such a benefit input/output device, and/or (ii) communicate with a central server that manages the accounting associated with such ticket-in/ticket-out transactions (e.g., so as to track the issuance, redemption and expiration of such tickets). One example of ticket-in/ticket-out technology that may be adapted or utilized to implement embodiments described herein is the EZ Pay™ system, is manufactured by International Gaming Technology, headquartered in Reno, Nev.

Of course, as would be understood by one of ordinary skill in the art, a gaming device may comprise various combinations of any or all of the component devices described herein. For example, in one or more embodiments, the gaming device may include more than one display device, one or more other output devices, several input devices, and so on (e.g., two display screens, two audio speakers, a headset, a ticket-in/ticket-out device and several buttons).

The processor 405 is also in communication with a payment system 460, which may be a component of gaming device 400. The payment system 460 is a device capable of accepting payment from a player (e.g., a bet or initiation of a balance, a payment in exchange for gaining access to supplemental audio, a payment in exchange for supplemental audio already output).

Exemplary methods of accepting payment by the payment system 460 include (i) receiving hard currency (i.e., coins or bills), and accordingly the payment system 460 may comprise a coin or bill acceptor; (ii) receiving an alternate currency (e.g., a cash-out ticket, a coupon, a non-negotiable token), and accordingly the payment system 460 may comprise a bar code reader or other sensing means; (iii) receiving a payment identifier (e.g., a credit card number, a debit card number, a player tracking card number, a code via a keypad or touch-screen); (iv) receiving a smart card having an indication of an amount of currency stored thereon; and (v) determining that a player has performed a value-added activity (e.g., participating in surveys, monitoring remote images for security purposes, referring friends to the casino).

The processor 405 is further operable to communicate with a player tracking device 445, which may be a component of gaming device 400. Player tracking device 445 may, in one or more embodiments, comprise a reader device operable to read information from and/or write information to a card such as a smart card and/or a player tracking card, such that (i) players may be identified, and (ii) various data associated with players may then be determined. For example, a type of supplemental audio previously selected by the player, a headset previously registered by a player, a payment previously provided by a player in exchange for supplemental audio and/or an another indication of a player's qualification to receive supplemental audio may be determined based on information associated with the player identifier. Similarly, a number of cashable credits available to the player may be determined, a number of promotional credits that may not be redeemed for cash but that are associated with the player may be determined, a code or other indication of a benefit to be provided to the player may be determined, a number of accumulated loyalty points associated with the player may be determined, a number of accumulated game elements such as symbols, cards or hands associated with the player may be determined, etc. In one example, a card reader device may determine an identifier associated with a player (e.g., by reading a player tracking card comprising an encoded version of the identifier), such that the gaming device may then access data (e.g., of a player database, a session database) associated with the player. In another example, a smart card reader device may determine data associated with a player directly by accessing a memory of an inserted smart card.

As described in more detail below, a player database may be used, for example, to store player wager data (e.g., such that players wagering over a given threshold in a given amount of time may be rewarded for their patronage, qualify for output of supplemental audio, and so on). The player database may also contain other information that may be useful in, for example, promoting and managing player behaviors (e.g., information about the player's gaming preferences, lodging arrangements, and the like). Further, the player database may store data regarding a given player's standing in a game session and/or a bonus game and/or where a player left off in listening to supplemental audio, so that the player can continue the game session, bonus game or supplemental audio at a plurality of game machines that have common access to the player database. Such player data may be stored in a relational database and retrieved or otherwise accessed by the processor after receiving a “key” data point from the player, such as a unique identifier read from the player's player tracking card or cashout ticket.

In one embodiment, the player tracking device 445 may comprise (i) a card reader (e.g., a port into which player tracking cards may be inserted), (ii) various input devices (e.g., a keypad, a touch-screen), (iii) various output devices (e.g., a small, full-color display screen), and/or (iv) combinations thereof (e.g., a touch-sensitive display screen that accommodates both input and output functions). Various commercially available devices may be suitable for such an application, such as the NextGen™ interactive player tracking panel manufactured by IGT or the iVIEW display screen manufactured by Bally® Gaming and Systems.

As known in the art, “smart cards” may incorporate (i) a memory, and (ii) means for accessing such a memory. For example, in one embodiment, the memory may store data related to aspects of the present invention. In one embodiment, data may be written to the smart card as a player plays one or more gaming devices (e.g., such that various data may be updated on a continuous, periodic or event-triggered bases). Accordingly, in one or more embodiments one or more devices operable to carry out various processes of the present invention (e.g., a gaming device or controller 205) may have associated therewith a smart card reader device, such that data may be read from the smart card pursuant to the execution of such processes. An example of a smart card system that may be used to implement one or more embodiments of the present invention is the s-Choice™ Smart Card Casino Management System from Smart Card Integrators, Inc.™.

Of course, other non-card-based methods of identifying players are contemplated. For example, a unique identification code may be associated with the player. The player may then be identified upon entering the code. For example, the code may be stored (e.g., within a database maintained within a gaming device or controller 205) such that the player may enter the code using an input device of a gaming device, and accordingly allow the player to be uniquely identified. In other embodiments, player biometrics may serve as identification means (e.g., a player is identified via a thumbprint or retinal scan of the player). In further embodiments, a barcode of a cashless gaming ticket may encode a player identifier.

Thus, as described, various data associated with a player may be tracked and stored (e.g., in an appropriate record of a centrally-maintained database), such that it may be accessed as desired (e.g., when registering and/or otherwise qualifying a player to receive supplemental audio, when receiving a player's selection of a preferred supplemental audio or supplemental audio type, when receiving a payment from a player for supplemental audio already output to the player and/or supplemental audio to be output to the player, and so on). Further, various statistics may be measured in association with a player (e.g., coin-in statistics, win/loss statistics, buy-in amount for a session) and similarly accessed.

Various systems for facilitating such monitoring of player behavior and activity are contemplated. For example, a two-wire system such as one offered by International Gaming Systems (IGT) may be used. Similarly, a protocol such as the IGT SAS™ protocol or the IGT SuperSAS™ protocol may be used. The SAS™ protocol and the SuperSAS™ protocol each allows for communication between gaming machines and slot accounting systems and provides a secure method of communicating all necessary data supplied by the gaming device to the online monitoring system. One aspect of the SAS™ protocol and the SuperSAS™ protocol that may be beneficial in implementing aspects of the present invention is the authentication function which allows operators and regulators to remotely interrogate gaming devices for important memory verification information, for both game programs, and peripheral devices. In another example, a one-wire system such as the OASIS™ System offered by Aristocrat Technologies™ or the SDS slot-floor monitoring system offered by Bally Gaming and Systems™ may be used. Each of the systems described above is an integrated information system that continually monitors slot machines and customer gaming activity. Thus, for example, any one of these systems may be used to monitor a player's gaming activity in order to determine player outcomes, buy-in amounts, coin-in statistics, win/loss statistics and/or any other data deemed relevant.

In one embodiment, a player may operate a plurality of gaming devices. For example, a player may simultaneously play two side-by-side gaming devices, a player may play one gaming device (e.g. a gaming device) and then continue his gaming session at another gaming device (e.g. a video poker machine), and a player may remotely operate a gaming device, possibly by using a telephone, PDA, headset or other device (i) to transmit commands (directly or indirectly) to the gaming device, such as wager amounts and commands to select certain cards; and/or (ii) to receive output (directly or indirectly) from the gaming device.

In one embodiment, a gaming device may allow a player to play a game of skill rather than a game of chance. Such an embodiment may be more appealing to certain players or may be permitted in areas where it is illegal to gamble on games of chance.

In one or more embodiments, aspects of the present invention, such as facilitating play of a gaming device under the terms of a contract (e.g., providing a benefit during a period of time defined by the contract and/or monitoring the play to determine compliance with the contract), may be practiced by replacing and/or augmenting one or more components (e.g., hardware and/or software components) of an exisfing gaming device. Thus, in one or more embodiments, the invention may be applied as a retrofit or upgrade to existing gaming devices currently available for play within various casinos.

For example, a memory (e.g., computer chip) of the gaming device may be replaced or added, the replacement or additional memory storing a program for instructing the processor of the gaming device to operate in accordance with one or more embodiments. In another example, data output via the gaming device (e.g., graphical and/or textual data displayed on the gaming device) may be replaced or added, the replacement or additional data indicating to a player information relevant to one or more aspects of the present invention.

In a specific example, a gaming device may comprise various electronic components mounted to one or more printed circuit boards (PCBs). Such components may include various hardware described herein, such as a communications port and various controllers of peripheral devices (e.g., a display controller), as well as a memory for storing programming instructions (software) and a processor for carrying out such instructions. Forms of memory that may be found in a gaming device include electronically erasable programmable read-only memory (EEPROM), erasable programmable read-only memory (EPROM) and flash memory. Thus, in one or more embodiments of the present invention, an EPROM storing software with instructions for carrying out aspects of the present invention (as well as instructions for carrying out other functions traditionally performed by the gaming device) may replace an EPROM previously installed in a gaming device or may be reprogrammed in accordance with one or more embodiments described herein, such that the gaming device may be configured to operate in accordance with various processes described herein.

For example, a “supplemental audio” module may be made available for purchase to various casino operators. The module, which may comprise various hardware and software (e.g., an EEPROM storing software instructions and a headphone jack module that may be attached to a gaming device), may be installed in an existing gaming device (e.g., a video-reel slot machine, a video poker machine, etc.), such that when the module is installed, players of the device may elect (i) to play the gaming device in a manner that does not incorporate embodiments described herein, or (ii) to play the gaming device in a manner that incorporates embodiments described herein (e.g., be eligible for output of supplemental audio). Thus, players who are familiar with operating a gaming device may elect to pay for them in a different or similar manner as they are accustomed to.

Accordingly, a gaming device may be configured to allow a player to select one of two “modes” of the gaming device, and to enable the selected mode. If a player selects a “standard” mode, the gaming device may be configured to operate in a manner similar to how it operated before the installation of the module (e.g., the gaming device operates in a conventional manner, such that embodiments described herein may not be utilized). If a player selects the “supplemental audio” mode, the gaming device may then be operable to execute game play in accordance with one or more embodiments described herein.

In one example of allowing a player to select one or more modes, a touch-sensitive display screen may be configured to output a prompt asking a player to select a mode of operation. Such a prompt may be output in occurrence to various trigger conditions (e.g., coins, bills or tickets are inserted; a credit balance increases from zero to some other number; a player presses a “play” button; a motion, weight, infrared or other sensor detects the presence of a player; etc.). Accordingly, a player may select a mode of operation (e.g., by pressing an appropriately labeled icon of a touch-sensitive display screen), and upon receiving the player's selection, the gaming device may be configured to operate in the selected mode.

In another embodiment, a gaming device may be operable to automatically determine whether it should switch modes from a standard mode to a “supplemental audio” mode. A gaming device may perform such a determination, for example, by evaluating data received from a player and/or another device and/or by querying another device. For example, a gaming device may be programmed to determine (e.g., upon receiving a player identifier and based upon the player identifier) whether the player currently playing the gaming device qualifies to receive output of supplemental audio. In another embodiment, a gaming device may be programmed to recognize that a player has requested output of supplemental audio and/or output of a particular supplemental audio or a particular supplemental audio type. Upon determining that a player has indicated a desire to receive supplemental audio and/or that a player qualifies to receive supplemental audio, a gaming device may further be programmed to retrieve and/or output the supplemental audio. For example, the gaming device may be programmed to access data (e.g., available supplemental audio) stored on another device (e.g., controller 205.) or query such other device for an answer to the determination. If the gaming device determines that the player qualifies for output of supplemental audio and/or has indicated a desire to receive supplemental audio, the gaming device may switch from a standard mode to a “supplemental audio” mode. In “supplemental audio” mode, for example, a gaming device may be operable to open an audio file and transmit the supplemental audio of the file via a private audio channel (e.g., via a headset). In one embodiment, a gaming device may be operable to output an indication that it is currently in “supplemental audio” mode (e.g., to inform a player that the current play of the gaming device that supplemental audio is available for output to the player). For example, the gaming device may turn on a light, change graphics, output a sound, etc.

In other embodiments, as described, a peripheral device may be useful for implementing one or more embodiments of the present invention into the operation of a conventional gaming device. For example, in order to avoid or minimize the necessity of modifying or replacing a program already stored in a memory of a conventional gaming device, an external or internal module that comprises a peripheral device may be inserted in, connected to or otherwise associated with the gaming device. Such a peripheral device may be operable to, for example, monitor and/or transmit information about a player's gambling activity at the gaming device to another device (e.g., controller 205). The peripheral device may monitor and/or transmit such information to enable a determination of whether a player has qualified to receive supplemental audio (e.g., whether the player has provided appropriate payment and/or engaged in qualifying gaming activity) and/or whether a player to whom supplemental audio is being output continues to qualify for output of the supplemental audio.

In still further embodiments, rather than configure existing gaming devices to execute embodiments described herein by installing or connecting new hardware and/or software, software may be downloaded into an existing memory of one or more gaming devices. U.S. Pat. No. 6,805,634 to Wells et al. teaches methods for downloading data to gaming devices in such a manner. The entirety of U.S. Pat. No. 6,805,634 is incorporated by reference herein for all purposes. Thus, in some embodiments, an existing gaming device may be reprogrammed to accommodate new functionality of the present invention without the need, or by minimizing the need, to remove and replace hardware within the gaming device.

In one embodiment, a gaming device 400 or another device operable to carry out one or more embodiments described herein (e.g., a kiosk) may be operable to output a menu of available supplemental audio or types of available supplemental audio to a player via a player interface. A player interface may comprise, for example, a video screen that is a touch screen operable to display such one or more such menus. A menu so displayed to a player may provide the player with, for example, a choice of available supplemental audio or available types of supplemental audio. In another example, a menu so displayed to a player may provide the player with supplemental audio for which the player is currently eligible (e.g., based on the player's wagering history, a game the player is playing or other information associated with the player and/or gaming device the player is currently playing). A player may be presented with a menu of options via a touch screen, for example, upon indicating a desire to consider options available via such a menu and/or upon initiating play at the gaming device 400. A player may select an option from such a menu by touching the area of the screen on which the option appears.

It should be appreciated that one or more embodiments may include storing graphic and/or sound elements that are used to construct the menu of available options. These elements may be store, for example, in EEPROM, flash memory, hard disk, CD ROM, or in any other suitable storage device. The menu may be displayed via any suitable display device, such as a CRT, LCD, VFC, LED display. In one embodiment, the menu may be implemented using only dedicated electromechanical switches. In one embodiment, a player operates an input device of the device operable to display the menu, in order to cause the menu to be displayed. In one embodiment, the device includes a touch screen and a touch screen controller (not shown) associated with a video monitor display device. The touch screen and touch screen controller may be operable to communicate with a video controller of the video monitor display device and a processor (e.g., a processor of gaming device 400). Thus, a player may be enabled to indicate decisions (e.g., which supplemental audio or type of supplemental audio the player desires to view more detailed information about, which supplemental audio or type of supplemental audio the player desires to hear and/or purchase, etc.) by touching the touch screen in the appropriate places.

In one embodiment, display of the menu preempts display of other information. For example, in one embodiment the same display device or screen used to display indicia indicative of an outcome by displaying the indicia as disposed along a payline during active game play may be used to display a menu of available supplemental audio to a player upon an indication of a player to view the menu. In another embodiment, a dedicated display device or screen may be used to display a menu of available supplemental audio on a continuous, periodic, or other basis.

Processor 405 may further be operable to communicate with a fist audio output element 465 and a second audio output element 470. One of the audio output elements 465 and 470 may comprise an audio output element functioning as a private audio channel such that sounds therefrom are not audible to general passersby of the gaming device 400. For example, one of the audio output elements 465 and 470 may comprise a headset. As described, in some embodiments of the present invention, a gaming device may comprise an external headset connector (also referred to herein as a headphone jack), such as headphone jack 455. Such a connector may enable communication between a gaming device and a headset device (e.g., such that when a headset device is connected or otherwise activated by a player, audio signals may be output from the gaming device to the headset device). In some embodiments, an external headset connector may enable both input and output functions. For example, an external headset connector may comprise a USB port. As is known in the art, a processor may be configured to detect the connection of a device such as a headset device via a USB port (e.g., a program stored within a gaming device memory may enable that peripheral devices connected via the USB port are “plug-and-play” devices). The headset device may then serve as an output device (e.g., audio signals are output to the headset) as well as an input device (e.g., a player speaks into a microphone of a headset device). In other embodiments, an external headset connector may enable only output functions. For example, an external headset connector may comprise a ⅛″ (3.5 mm) or ¼″ stereo or mono audio jack, such that when a headset device is connected via the jack (e.g., the insertion of a plug into the jack enables electrical connectivity), audio may be output to the headset device. In various embodiments, an external headset connector may be located on a front panel or other portion of a cabinet of a gaming device, on a chair associated with a gaming device, and so on.

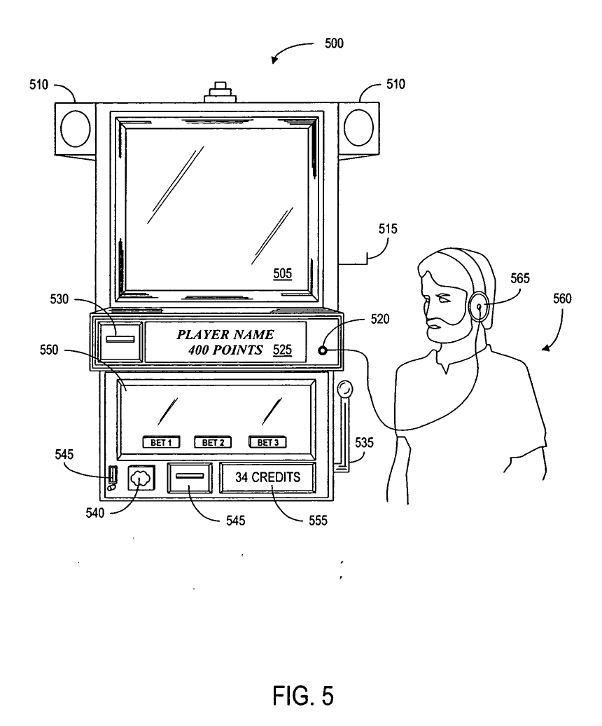

Referring now to FIG. 5, illustrated therein is a plan view of an example embodiment 500 of a gaming device in the form of a slot machine. Embodiment 500 is referred to as slot machine 500 herein. Generally, a slot machine for use in the present invention may, in one embodiment, comprise a three reel or five reel slot machine (e.g., in the form of a mechanical reel or a video slot machine).

The slot machine 500 comprises a display area 505 in which an outcome for a game of the slot machine is displayed to the player. The display area 505 may, for example, be a video display that displays graphical representations of reels. The display area may, in another example, be glass behind which are located mechanical reels. Within the display area may be a payline. In accordance with one or more embodiments of the present invention, an outcome of a game is a set of symbols or indicia displayed along a payline of a reeled slot machine.

The slot machine 500 may further comprise one or more speakers 510, which may be embodiments of a primary audio output element of the slot machine. The speakers 510 may each be configured, for example, to output primary game related audio to a player of the slot machine, which primary game related audio may further be audible to passersby of the slot machine 500.

The slot machine 515 may further include a hook 515 or other mechanism for holding a set of headphones or other type of supplemental audio output element. In some embodiments, headsets may be permanently connected to or otherwise associated with a gaming device (e.g., a slot machine stationed on a casino floor comprises a “stationary headset” connected to the slot machine via audio cabling). In one such embodiment, a gaming device may comprise a hook, bin or other device for holding headsets (e.g., element 515 of slot machine 500). In some embodiments, “mobile headsets” may be portable from gaming device to gaming device (e.g., a player may unplug a headset from a first gaming device, and plug the headset into a second gaming device). In one such embodiment, a headset may comprise a memory as described for storing data (e.g., a player identifier) as will be described herein. Further, such a mobile headset may communicate with a gaming device in a variety of manners. In “mobile headset” embodiments, a hook 515 or other mechanism for storing a headset may not be necessary and/or preferred.

Slot machine 500 also comprises a headset communication element 520 via which a headset may be connected or otherwise communicate with slot machine 500. In one embodiment, a non-wireless mobile headset may be connected to and removed from a gaming device via a port (e.g., a ⅛″ audio jack, a USB port, etc.). In such an embodiment, headset communication element 520 may comprise an audio jack. In another embodiment, a headset and gaming device and/or controller may transmit data wirelessly in any manner described herein or known in the art. In such an embodiment, headset communication element 520 may comprise, for example, an IR, RF, Bluetooth™ enabled or other wireless communication transmitter and/or receiver operable to transmit data to and/or receive data from a wireless headset.

As illustrated in FIG. 5, in one embodiment headset communication element 520 may comprise an audio jack into which an end of a wire connected to a headset may be plugged. A player 560 may thus listen to supplemental audio while playing slot machine 500, via a headset 565.

As described, in some embodiments, a supplemental audio output element may comprise a headset. A headset may comprise a device worn or otherwise used by a player, which device may be configured to output supplemental audio to a player via a private audio channel. Exemplary headsets include stereo headphones, stereo earphones, a monaural earphone, and so on. In some embodiments, a headset may additionally comprise one or more input devices (e.g., a microphone, a button or other control for changing a volume level, etc.), as well as output devices (e.g., an LED display indicating a current volume level, a currently selected supplemental audio channel, or other data). Also, such headsets comprising microphones may comprise noise-cancellation technology as is known in the art, such that undesired sounds may be eliminated or reduced.

A variety of commercially available headsets may be used in various embodiments with the present invention. For example, in some embodiments, a headset may comprise a set of stereo earphones or headphones traditionally used in conjunction with portable audio devices (e.g., portable CD players). Examples of such earphones include a number of products manufactured and distributed by Sony Corporation (or divisions thereof), such as any model in the Fontopia® series of ear-bud style earphones, including models MDR-EX51LP, MDR-ED21LP, MDR-E818LP, and so on. Additionally, headphone models comprising an adjustable headband may be used, such as the MDR-301 LP. Further, a monaural earphone such as the MDR-E5 may be used. It should be noted that such headphones and earphones typically comprise an audio cord ending in a ⅛″ plug (e.g., which may then be inserted into a standard ⅛″ (3.5 mm) input jack of a gaming device operable in accordance with embodiments described herein to establish connectivity).

In other embodiments, a headset may comprise a device traditionally used in conjunction with a personal computer. Thus, in some embodiments, a headset may comprise a device such as the Audio70, manufactured by Plantronics, Inc., of Santa Cruz, Calif. Such a device may comprise (i) stereo earphones, which may be connected to a ⅛″ jack of a gaming device dedicated to outputting sound (e.g., a “headphone input”), as well as (ii) a microphone, which may be connected to a ⅛″ jack of a gaming device dedicated to receiving sound (e.g., a “microphone input”). In another example, a headset such as the DSP-500 offered by Plantronics, Inc. may comprise a USB cable, such that the headset may be connected to a USB port of a gaming device and/or controller.

In another embodiment, a headset may comprise a wireless headset traditionally used in conjunction with a personal computer, such as the 9120 model manufactured by GN Netcom, Inc. of Nashua, N.H. Such a unit may comprise a wireless headset in communication with a base receiver unit. For example, in one or more embodiments, a base receiver unit and wireless headset may be configured to transmit data at a radio frequency of 5.8 GHz, 2.4 GHz or 900 MHz. A base receiver unit may then be configured to communicate with a gaming device 400 and/or controller 205 (e.g., digitally, via a USB connection). In some embodiments, a gaming device may comprise such a base receiver unit (e.g., such that a wireless headset may communicate with the gaming device directly via RF transmission or any means of wireless data transmission described herein).

In further embodiments, a Bluetooth™-enabled headset may communicate with a user device wirelessly (e.g., with a cellular phone, as described further herein). For example, a casino may issue Bluetooth™-enabled wireless headsets, such as the M3500 manufactured by Plantronics, Inc., to players who possess compatible cellular phones or other user devices (e.g., a Bluetooth™-compatible phone, such as the 3650 model manufactured by Nokia of Finland). Accordingly, as will be described, in some embodiments, a controller 205 and/or gaming device 400 may be configured to communicate with a user device (e.g., a controller 205 and/or gaming device 400 may be configured to dial a cellular phone number provided by a player and/or receive incoming cellular phone calls from players via an IVRU) such that audio signals may be transmitted to the user device (e.g., the player may then hear audio signals via a cellular phone in connection with a controller 205 and/or gaming device 400).

As stated, in some embodiments, a headset device may additionally comprise one or more input devices, such as a microphone or volume adjuster. In some embodiments, an input device of a headset device may be configured to send instructions to a gaming device processor such that a gaming device component, feature or game may be activated. For example, affixed to the wire of a headset device may be a control section, which may comprise a 'spin” button for actuating the reels of a slot machine, a “cash out” button for actuating a coin hopper to dispense coins, and so on. In other embodiments, a player may verbally instruct the slot machine to perform a command (e.g., by speaking “Spin!” into a microphone of a headset device). In one embodiment, a player may respond to offers output to the player via the headset by speaking an acceptance or rejection of the offer into a microphone component of the headset, which response may be transmitted to the processor of the gaming device for further processing. Similarly, in some embodiments a player may respond to questions (e.g., survey questions) output to the player via the headset by speaking the answers into the microphone.

The slot machine 500 may also include a secondary display device 525, for outputting information to a player. The secondary display device 525 may be utilized, for example, to output (i) bonus game information (e.g., by displaying animated video for the bonus game and a result of a bonus round that is part of a system supported bonus game), (ii) complimentary point information (e.g., how many complimentary points a player currently has available); (iii) information about special credits or other resources available to the player, and/or (iv) any other information deemed desirable and/or appropriate. In one embodiment, the secondary display device 525 may comprise a display device of a player tracking module. In that regard, the slot machine 500 may further include a player tracking card interface 530, via which a player may insert a player tracking card or other card (e.g., a smart card, a financial account card, etc) into the gaming device.

The slot machine 500 may further comprise a handle 535 or other means for initiating a game play or bonus round. A player may initiate the movement of the reels in the display area 505, for example, by pulling on the handle 535. Alternatively, a player may initiate the movement of the reels in the display area 505 by actuating a start button 540. Either or both of the handle 505 and start button 540 are exemplary embodiments of the input device 450 (FIG. 4), described herein.

The slot machine 500 may also include a payment system 545 (which may be, e.g., a form of payment system 460 if FIG. 4), which may comprise one or more of a bill acceptor, a credit card reader, cashless receipt/ticket reader, and a coin acceptor. A player may utilize payment system 545, for example, to provide a wager for playing a game and or for providing payment for supplemental audio.

The slot machine 500 may further comprise a player interface 550. A player interface, as the term is used herein, may comprise a component of a device (e.g., slot machine 500) operable to receive input from a player and/or to output information to a player regarding one or more options available to the player via the device. For example, a player interface may be operable to receive input from a player such as an indication of a wager amount, an indication of a selection of supplemental audio, an indication of a selection of one or more games and/or features available via the gaming device, etc.

In one embodiment, a player interface 550 may comprise a number of physical buttons (e.g., mechanical or electromechanical buttons) that are actuated to initiate one or more functions or subroutines. For example, the player might actuate a button labeled “Cashout” to end a gaming session. In another example, a player might actuate a button labeled “Bet 1” in order to indicate a selection of one (1) credit wager for the next immediate game play. In one embodiment, a player interface comprises a plurality of mechanical or electromechanical buttons, wherein each button is operable to display information about an option available to the player.

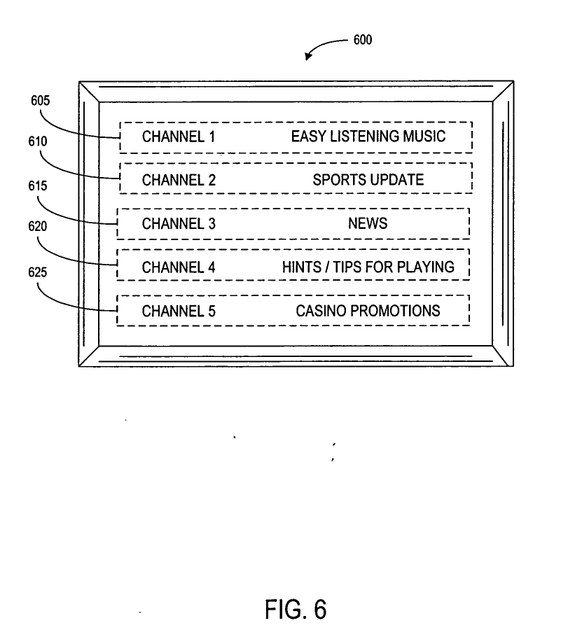

In another embodiment, a player interface 550 may comprise a touch screen depicting a menu of options available to the player, wherein the player selects an option by touching an area of the touch screen that corresponds to the option. For example, a player interface 550 may be operable to output a menu of available types of supplemental audio and/or a menu of available supplemental audio channels and a description of the supplemental audio currently playing via each respective supplemental audio channel (e.g., as illustrated in FIG. 6).

In one embodiment, information output via a player interface 550 may be selectively output. For example, a player may be presented with the menu of options upon indicating a desire to consider the options and/or upon initiating play at the slot machine 500.

In one embodiment, a player interface 550 comprising a touch screen or another form may be displayed on the same display device that displays other information. For example, display area 505 may be operable to, at one time, output animated video of a bonus round and, at another time, output a menu of options available to the player.

In one embodiment, a single display device may be operable to simultaneously display two or more types of information. For example, the same display device may be operable to display a payout table and a menu of options available to the player (e.g., one or more types of supplemental audio available for purchase, and the corresponding prices corresponding to each type of supplemental audio).

In one embodiment, information displayed via a player interface 550 may be updatable remotely (e.g., based on an input from a processor and/or casino personnel).

In one embodiment, any and all of the display devices described herein (e.g., display area 505, secondary display screen 525) may comprise a player interface 550.

In one embodiment, a player may be allowed to purchase or request output of supplemental audio at any time during play of a gaming device. In another embodiment, the times at which a player may be allowed to request output of supplemental audio may be restricted in one or more manners. For example, a button corresponding to output of supplemental audio (e.g. which button may indicate an availability of supplemental audio) may be activated (and, e.g., lit up to indicate activation), and thus actuatable to cause a subroutine consisting of output of supplemental audio, at some times but not at others. For example, if a player plays at a predetermined rate or engages in other activity (e.g., answering survey questions, wagering maximum bet, etc) that satisfies a condition that is a pre-requisite for output of supplemental audio, such a button may be activated. Such a button may be a mechanical or electromechanical button or a virtual button on a touchscreen.

The slot machine 500 may further comprise a credit meter balance 555, which is an exemplary embodiment of a benefit output device 435 (FIG. 4) as described herein. The credit meter balance 555 indicates the amount of electronic credits currently available to a player for wagering and/or providing payment for options available via the slot machine 500. The electronic credits may be used by a player, for example, as wagers for game plays played on the gaming device and/or for providing payment for a play session and/or supplemental audio. The electronic credits may also be “cashed out” as coins, bills, tokens, a cashless gaming receipt, and/or credits to another financial account associated with the player.

Referring now to FIG. 6, illustrated therein is one example of a menu 600 of supplemental audio options that may be displayed to a player (e.g., via player interface 550 of slot machine 500). As illustrated in FIG. 6, in one embodiment, various supplemental audio channels may be available to a player, each supplemental audio channel playing a different type of supplemental audio. Thus, for example, a player may indicate a type of supplemental audio the player desires to listen to and/or indicate a desire to obtain more information about a particular type of supplemental audio by touching an appropriate area of the touchscreen depicting the menu 600.

For example, if the player were to touch area 605, the player would be indicating a desire to listen to (and/or obtain further information on) supplemental audio channel 1 and thus listen to easy listening music. Similarly, if the player were to touch area 610, the player would be indicating a desire to listen to (and/or obtain further information on) supplemental audio channel 2 and thus listen to sports updates (e.g., to track his bets on a live sporting event). Similarly, if the player were to touch area 615, the player would be indicating a desire to listen to (and/or obtain further information on) supplemental audio channel 3 and thus listen to news. Similarly, if the player were to touch area 620, the player would be indicating a desire to listen to (and/or obtain further information on) supplemental audio channel 4 and thus listen to hints/tips for playing a game. Similarly, if the player were to touch area 625, the player would be indicating a desire to listen to (and/or obtain further information on) supplemental audio channel 5 and thus listen to casino promotions and/or promotions from entities other than a casino. It should be noted that, in some embodiments, such promotions may be customized for the player and/or may be responded to by the player (e.g., a player may accept an offer output via a headset).

It should be noted that, in some embodiments, the channels initially output to a player as available audio channels (e.g., such as channels 1-5 in FIG. 6) may include sub-channels that a player may access by selecting one of the initially displayed channels. For example, in one embodiment, a player selecting touch area 615 of FIG. 6 and thus indicating an interest in the news channel may then be presented with several options of sub-channels that fall into the news category. For example, the player may be presented with an option of listening to NPR News, CNN News, MSNBC News or BBC News. Similarly, a player selecting touch area 620 and thus indicating an interest in listening to hints or tips via channel 4 may be presented with a list of options for the games or types of hints the player would like to listen to. For example, the player may have the option of selecting the game for which the player would like to hear hints and tips (in other embodiments this selection may be made on behalf of a player who selects audio channel 4, based on the particular game the player selects to play) and/or the advancement or complexity level of the hints or tips. For example, a player who is playing a game for the first time or one of the first times may desire a “basic” advancement or complexity level, in which the hints or tips are geared towards educating the player as to the basics of the game. However, a player who is experienced at playing a game may select a more advanced level of hints or tips, such that the player is educated as to the more nuanced, hidden or unobvious aspects of the game. It should be noted that, in embodiments in which a player pays a fee or provides another form of consideration in exchange for access to supplemental audio, different prices or magnitudes of consideration may be associated with different sub-channels of a category (e.g., a player may gain access to basic tips for free but may be required to listen to a promotional offer and/or participate in a survey in order to gain access to more advanced hints or tips).

Various databases that may be useful in some embodiments will now be described. Example structures and sample contents of the (i) a player database 325; (ii) a headset database 330; (iii) a registered supplemental audio database 335; (iv) a supplemental audio output rules database 340; and (v) a supplemental audio trigger database 425 are shown in FIGS. 7A-11, respectively. The specific data and fields illustrated in these drawings represent only some embodiments of the records stored in the databases described herein. The data and fields of these databases can be readily modified, for example, to include more or fewer data fields. A single database also may be employed. Note that in the databases, a different reference numeral is employed to identify each field of each database. However, in at least one embodiment, fields that are similarly named (e.g., headset identifier fields) store similar or the same data in a similar or in the same data format.

Example embodiments of the databases 325, 330, 335, 340 and 425 are described in detail below and example structures are depicted with sample entries in the accompanying figures. As will be understood by those skilled in the art, the schematic illustrations and accompanying descriptions of the sample databases presented herein are exemplary arrangements for stored representations of information. Any number of other arrangements may be employed besides those suggested by the tables shown. For example, even though seven separate databases are illustrated, the invention could be practiced effectively using one, two, three, four, five, six, eight or more functionally equivalent databases. Similarly, the illustrated entries of the databases represent exemplary information only; those skilled in the art will understand that the number and content of the entries can be different from those illustrated herein. Further, despite the depiction of the databases as tables, an object-based model could be used to store and manipulate the data types of the present invention and likewise, object methods or behaviors can be used to implement the processes of the present invention.

It should also be noted that some or all of the data or types of data illustrated in FIGS. 7A-11 may be stored and managed in individual ones of the gaming devices, the contract kiosks 140, and/or a contract server, and may be used therein to manage, control and/or monitor contract play modes of the gaming devices 130.

Referring now to FIG. 7A and FIG. 7B, illustrated therein is a tabular representation of an example embodiment 700 of a player database. Embodiment 700 is referred to as player database 700 herein. A player database 700 may be stored in a memory of a device (e.g., memory 315 of controller 300 and/or memory 410 of gaming device 400) in tabular form, or any other appropriate database form, as is well known in the art. The data stored therein may include a number of exemplary records or entries, including records R700-1 through R700-4, each defining a player. Those skilled in the art will understand that the player database 700 may include any number of entries.

The player database 700 may also define fields for each of the entries or records. The fields specify: (i) a player identifier field 705 that (e.g., uniquely) identifies a player; (ii) a name field 710 that indicates a name of the player; (iii) an address field 715 that indicates contact information associated with the player (e.g., a postal address, an e-mail address, a telephone number, a pager number or other information allowing the player to be contacted); (iv) a player since field 720 that indicates a date at which a player became a member of a casino slot club or otherwise began to be tracked by a casino or other entity; (v) a total wagered field 725 that indicates an aggregate amount that the player has wagered within a predefine period of time, or that the player has deposited in a gaming device or made available for wagering at a gaming device within a predefined period of time (e.g., since the player's wagers began to be tracked, during a current visit to a casino, within a current year, etc.), (vi) a theoretical win field 725 that indicates a theoretical win associated with the player for a predefined period of time; (vii) a registered headset identifier field 730 that indicates an identifier of a headset associated with a player, if any, for purposes of some embodiments; (viii) a hotel guest? field 735 that indicates whether the player is currently a registered hotel guest (or, e.g., has been a registered hotel guest in the past); and (ix) group members field 740 that indicates one or more other players or persons that are associated with the player as a group, for purposes of some embodiments of the present invention.

Of course, the player database may include different and/or additional fields that store information such as, for example, (i) a financial account identifier of the player, which may be, e.g., a credit card, debit card or checking account number; (ii) demographic data about the player, such as the age, gender, income level of the player; (iii) credits and/or complimentary points which the player has accumulated in one or more previous and current plays at one or more gaming devices; (iv) what supplemental audio and/or type of supplemental audio the player prefers; and (v) whether the player has qualified and/or continues to qualify for output of supplemental audio.

A device (e.g., a controller 300 and/or gaming device 400) may utilize a player database 700 to determine, for example, whether a player has registered a particular headset as associated with the player and/or whether the player qualifies for output of supplemental audio and/or has a preference for a particular supplemental audio and/or type of supplemental audio. For example, one a player inserts a player tracking card into a gaming device operable to output supplemental audio, the player identifier of the player tracking card may be utilized to determine whether the player qualifies for output of the supplemental audio and/or what supplemental audio or type of supplemental audio is to be output to the player.

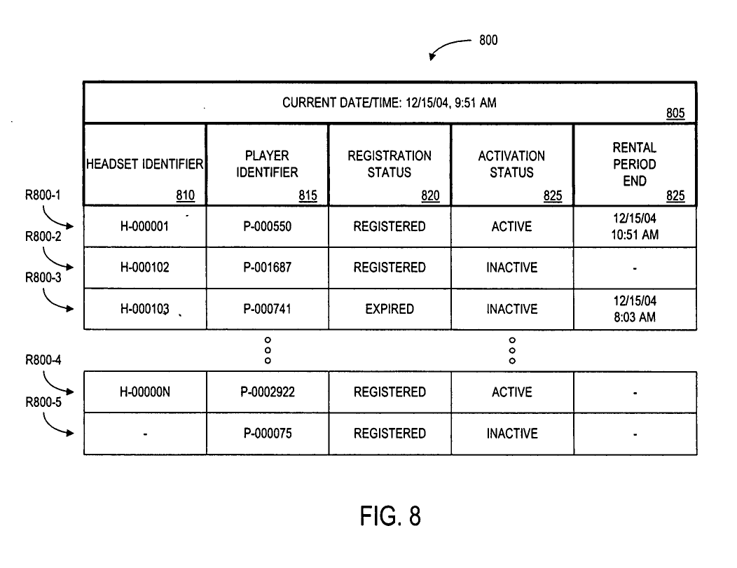

Referring now to FIG. 8, illustrated therein is a tabular representation of an example embodiment 800 of a headset database 330. Embodiment 800 is referred to as headset database 800 herein. A headset database 800 may be stored in a memory of a device (e.g., memory 315 of controller 300 and/or memory 410 of gaming device 400) in tabular form, or any other appropriate database form, as is well known in the art. The data stored therein may include a number of exemplary records or entries, including records R800-1 through R800-5, each defining a headset. Those skilled in the art will understand that the headset database 800 may include any number of entries.

The headset database 800 may be utilized, for example, to track headsets and information related thereto. For example, in one embodiment a player may rent, borrow or register a headset. In such an embodiment, upon a player renting, borrowing or registering a headset, an employee of an entity such as a casino may indicate in database 800 that the headset has been rented, borrowed or registered and is thus associated with a particular player.

In one embodiment, a player may be required to provide payment or other consideration (e.g., promise to play at least one gaming device for at least a period of time and/or in a particular manner, answer survey questions, playing of a gaming device in the past in a particular manner, etc.). In one embodiment, any player may rent or borrow a headset at any time, without having to provide payment or other consideration therefore and/or without having to qualify therefore.

In one embodiment, a player having rented a headset may still be required to qualify for output of supplemental audio by satisfying at least one other condition. In other words, in one embodiment a player renting or borrowing a headset may be insufficient for the player to receive supplemental audio via the headset. For example, the player may be required to provide payment for supplemental audio and/or otherwise qualify to hear supplemental audio beyond the rental or borrowing of the headset. In one embodiment, any player may receive output of supplemental audio at a gaming device by simply borrowing or renting a headset and utilizing the headset at a gaming device, without having to further qualify for output of the supplemental audio.

It should be noted that a headset may be borrowed, rented or registered at one or more of a variety of locations. For example, in one embodiment a player may visit a designated casino location (e.g., a counter or booth) to borrow, rent or register a headset. In another example, a player may borrow, rent or register a headset at a gaming device or by approaching a casino employee. It should be noted that, in one embodiment, a player may register a headset that already belongs to the player or is otherwise under the control of the player.

The headset database 800 may define fields for each of the entries or records. The fields may specify: (i) current time field 805 that indicates a current date and/or time of day; (ii) a headset identifier field 810 that indicates an identifier (e.g., a unique identifier) of a headset that a player has rented, borrowed or registered and/or of a headset that is available for renting, borrowing or registering by a player; (iii) a registration status field 820 that indicates a current status of a headset with respect to whether it is currently rented, borrowed or registered, whether the rental thereof has expired and/or whether it is currently available for borrowing, rental or registration; (iv) an activation status field 825 that indicates whether a corresponding headset is currently active (e.g., in use for outputting supplemental audio) or inactive; and (v) a rental period end field 825 that indicates a date and/or time at which a rental period associated with a headset is to expire or has expired.

For example, in one embodiment a player may pay for use of a headset and rent the headset in exchange for the payment. In such an embodiment, a rental period may be associated with the rental of the headset, such that the player may enjoy access (e.g., unlimited access) to supplemental audio via the headset for the duration of the rental period and until the end of the rental period. In one embodiment, the duration of the rental period may be commensurate with the magnitude of the payment (e.g., the player may rent a headset for $5.00/hour, thus if the player pays $20.00, the player may be entitled to hear supplemental audio via the headset for a period of four hours). It should be noted that in some embodiments a borrowed, rented or registered headset may not have an expiration time or a rental period end associated therewith. For example, in one embodiment a player may use a headset until he returns it and/or no longer desires to use it. In one embodiment, when a device (e.g., controller 300 and/or gaming device 400) determines that a player is attempting to use a headset to hear output of supplemental audio at a gaming device, the device may determine whether a rental period associated with the headset has expired before outputting the supplemental audio to the player.

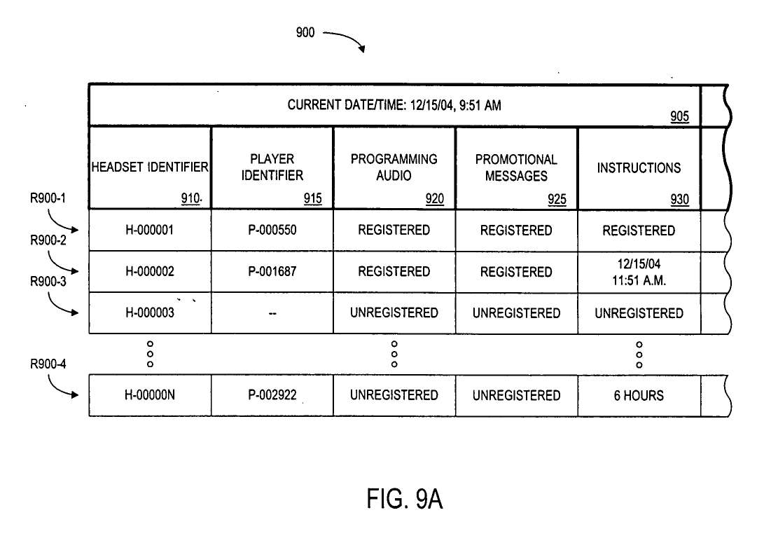

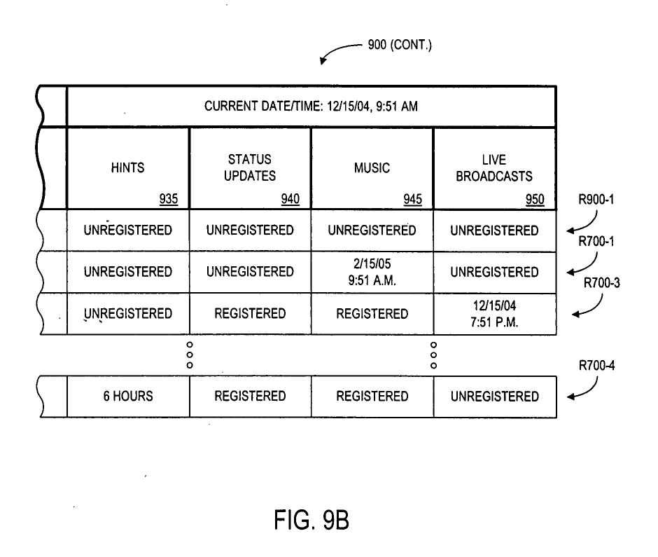

Referring now to FIGS. 9A and 9B, illustrated therein is a tabular representation of an example embodiment 900 of a registered supplemental audio database 335. Embodiment 900 is referred to as registered supplemental audio database 900 herein. A registered supplemental audio database 900 may be stored in a memory of a device (e.g., memory 315 of controller 300 and/or memory 410 of gaming device 400) in tabular form, or any other appropriate database form, as is well known in the art. The data stored therein may include a number of exemplary records or entries, including records R900-1 through R900-4, each defining a supplemental audio. Those skilled in the art will understand that the registered supplemental audio database 900 may include any number of entries.

The registered supplemental audio database 900 may be utlized, for example, to track a type of supplemental audio that a player has registered for, has indicated a preference for and/or has qualified for. For example, in some embodiments, a registration process may be performed which may comprise registering one or more types of supplemental audio in association with a headset identifier and/or player identifier. In various embodiments, a player may register and/or qualify for output of one or more types of supplemental audio. Data indicating a player's registration, qualification and/or preference for one or more types of supplemental audio may be reflected in a registered supplemental audio database, such as the one depicted in FIGS. 9A and 9B.

The registered supplemental audio database 900 may define fields for each of the entries or records. The fields may specify: (i) current time field 905 that indicates a current date and/or time of day; (ii) a headset identifier field 910 that indicates an identifier (e.g., a unique identifier) of a headset that a player has rented, borrowed, registered or is otherwise associated with (e.g., by virtue of playing a gaming device associated with the headset); (iii) a programming audio field 920 that indicates whether a player has registered for supplemental audio of the programming audio type; (iv) a promotional messages field 925 that indicates whether a player has registered for a supplemental audio of the promotional messages type; (v) an instructions field 930 that indicates whether a player has registered for supplemental audio of the instructional type; (vi) a hints field 935 that indicates whether a player has registered for supplemental audio of the hints type; (vii) a status updates field 940 that indicates whether a player has registered for supplemental audio of the status updates type; (viii) a music field 945 that indicates whether a player has registered for supplemental audio of the music type; and (iv) a live broadcasts field 950 that indicates whether a player has registered for supplemental audio of the live broadcasts type. Each of these types of supplemental audio is described in detail herein (e.g., below).

It should be noted that although FIGS. 9A and 9B indicate whether player has “registered” for certain types of supplemental audio, other indications of whether certain types of audio are to be output to a player may be stored in addition to, or in lieu of, whether a player has registered. For example, an indication of whether a player “prefers” a particular type of supplemental audio, has “requested” a certain type of supplemental audio (e.g., during a current play session or in the past), has “qualified” for a certain type of supplemental audio, has “paid” for a certain type of supplemental audio, and/or has had a certain type of supplemental audio output to him/her in the past may be stored.

It should further be noted that, in at least one embodiment, a player having registered for a certain type of supplemental audio may not necessarily qualify the player for output of the supplemental audio. For example, in one embodiment, a player registering for a certain supplemental audio may be a first step towards the player qualifying to hear the supplemental audio. The player may further be required to engage in a certain type of activity (e.g., play a qualifying gaming device at a qualifying speed) in order to qualify for output of the supplemental audio. In other embodiments, the player registering for a type of supplemental audio may be sufficient for the player to qualify for output of the supplemental audio.

Various processes for registering for a certain supplemental audio, a certain type of supplemental audio and/or for output of supplemental audio in general (rather than for a specific type) are contemplated. For example, a player may simply select a preferred type of supplemental audio at a gaming device and thus be considered registered for the type of supplemental audio. In another example, a player may have a default or available supplemental type of supplemental audio output to him/her and thus be considered to be registered for the type of supplemental audio. In yet another example, a player may pay and/or fill out a form (whether electronic or in paper form) to register for a certain type of supplemental audio.

Of course, embodiments are contemplated in which a player need not register to hear supplemental audio at all, but may simply utilize an available headset at a gaming device to hear supplemental audio. Similary, embodiments are contemplated in which there are not multiple types of supplemental audio available to a player. Further, embodiments are contemplated in which a player may be required to register for certain types of supplemental audio before qualifying to hear such types while having other types of supplemental audio available to players without requiring registration therefore.

A registered supplemental audio database 900 may be stored, for example, (i) within a controller, such that it may be accessed during play of a gaming device, (ii) within one or more gaming devices, and/or (iii) within a headset device, such that data may be accessed during play of a gaming device (e.g., data is transmit from a headset to a gaming device via a USB connection).

In embodiments in which a player registers for output of one or more types of supplemental audio, supplemental audio registration data may indicate a period of time for which a registration may last. For example, a registration may last (i) for a specified duration of time (e.g., as indicated in record R900-4, in one example it may be recorded that a player has purchased “6 hours” of hints), (ii) until a certain time/date (e.g., as indicated in record R900-2, in one example it may be recorded that a player may hear music until February 15^{th} at 9:51 a.m.), or (iii) permanently (e.g., as indicated in record R900-1, a player and/or headset may be considered permanently “registered” (or registered until he becomes unregistered for some reason) in association with a particular type of supplemental audio).

In one embodiment, a casino representative may enter supplemental audio registration data (e.g., using a computer in communication with a controller of the present invention) such that a supplementary audio database may populated appropriately (e.g., a customer who purchases an hour of instructional audio may receive instructions, because a registered supplemental audio database indicates the player is entitled to receive the type of supplemental audio). As stated, in some embodiments, a player may be automatically registered for one or more types of supplementary audio (e.g., by purchasing or renting a headset device). In other embodiments, a player may indicate (e.g., verbally to a casino representative, by filling out a form, etc.) one or more desired types of supplementary audio.

As shown by FIGS. 9A and 9B, in accordance with some embodiments a player may register for one or more of several different types of supplementary audio. Accordingly, several example types of supplemental audio will now be described in more detail.

(1) Instructional audio: Instructional audio may comprise information concerning (i) features or components associated with one or more gaming devices (e.g., instructional audio indicates “To begin play at this slot machine, insert a ten, twenty or fifty-dollar into the bill acceptor device”), (ii) game play associated with one or more gaming devices (e.g., “Here is your starting poker hand. Select the cards you'd like to hold”), (iii) game statistics associated with one or more gaming devices (e.g., “The payout percentage of this machine is currently set at 91%”), (iv) casino premises (e.g., “You are in Room D of the Eastern Wing. The closest restroom is located just behind you”), and so on. Thus, in some embodiments, instructional audio may be associated with one or more particular gaming devices (e.g., instructions are specific to a particular type of slot machine). It should be noted that one benefit associated with instructional audio may be the alleviation of apprehension new players may have toward one or more gaming devices.

In one embodiment, instructional audio may comprise evacuation/emergency information. For example, controller 205 could distribute different evacuation instructions to customers based on where they are sitting in relation to the nearest exit, how crowded the floor is (e.g. how many/which machines are in use), etc.

In one embodiment, instructional audio may relate to instructing or reminding a player about a feature or mode of a gaming device that is currently active and/or that the player is currently participating in. For example, the following messages could be output to a player: (1) “You currently have a negative balance. Remember, there is no need to pay this back at the end of the session;” and/or (2) “You are currently in Betting the Don't Mode. All normally winning outcomes like cherry-cherry-cherry will now result in a loss for you.”

(2) Hint-related audio: In some embodiments, a player receiving a hint may (i) receive a real advantage with respect to game play, and/or (ii) experience a perceived advantage with respect to game play. Several examples of hint-related audio are contemplated. In one example, a hint may provide a player with a real advantage by eliminating a non-preferable choice of a slot machine bonus round (e.g., “Don't select the box on the right. It contains fewer credits than the other boxes”). In another example, a hint may provide a player with a real advantage by revealing information about an otherwise unknown game parameter (e.g., “The box in the middle contains no credits,” “The next card in the deck is an A♥,” etc.). In yet another example, a hint may provide a player with a perceived advantage by providing statistical information (e.g., “The machine on your right may be due to pay out because it's been four hours since the last pay out occurred,” “75% of players choose the box on the right,” etc.). Thus, in some embodiments, hint-related audio may be associated with one or more particular gaming devices (e.g., hints are specific to a particular type of slot machine).

In one embodiment, hint-related audio may comprise instructions for perfect play of a video poker or other game. A player may, in some embodiments, be required to provide a payment in exchange for such audio. The amount of the payment may be based on, for example, the amount of money the casino could/would lose due to the perfect play (i.e. enough to profitably offset such a loss).

(3) Programming audio: In some embodiments, a gaming device may output audio/video programming in a variety of manners. Audio/video programming may comprise a television show, movie, live or prerecorded sporting event, cartoon, or other programming. In one or more embodiments, audio/video programming may be output via a secondary display area and may not affect game play (e.g., such that a player may watch a television show while playing a game). In other embodiments, audio/video programming may comprise or otherwise affect game play. For example, in one embodiment, a player may watch a television show, and the player may receive payouts in response to the occurrence of various actions or events within the television show (e.g., a player receives a payout of 15 coins if a character in the show says the word ‘money”). In another example, a player may watch a movie, and certain events or actions within the movie may trigger a conventional game play of a gaming device (e.g., if a car crashes in the movie, the reels of a slot machine are triggered to spin). Apparatus and methods which, among other things, permit and enable various ways of incorporating audio/video programming with play of a gaming device, and which are appropriate for use in accordance with the present invention are disclosed in: U.S. Pat. No. 6,234,896, filed Apr. 11, 1997, entitled “SLOT DRIVEN VIDEO STORY”; pending U.S. patent application Ser. No. 10/417,758, filed Apr. 16, 2003, entitled “GAMING DEVICE METHODS AND APPARATUS EMPLOYING AUDIO/VIDEO PROGRAMMING OUTCOME PRESENTATION”; pending U.S. patent application Ser. No. 10/417,733, filed Apr. 16, 2003, entitled “METHODS AND APPARATUS EMPLOYING AUTOMATIC AUDIO/VIDEO PROGRAMMING TO INITIATE GAME PLAY AT A GAMING DEVICE”; pending U.S. patent application Ser. No. 60/581,558, filed Jun. 21, 2004, entitled “GAMING DEVICE METHODS AND APPARATUS EMPLOYING AUDIO/VIDEO PROGRAMMING OUTCOME PRESENTATION”; pending U.S. patent application Ser. No. 60/581,563, filed Jun. 21, 2004, entitled “APPARATUS AND METHOD FOR EMPLOYING AUDIO/VIDEO PROGRAMMING TO INITIATE GAME PLAY AT A GAMING DEVICE”; and pending U.S. patent application Ser. No. 60/582,377, filed Jun. 23, 2004, entitled “GAMING DEVICE WITH OUTCOME COMPARISON FEATURE”; the entirety of each are incorporated herein by reference for all purposes.

Accordingly, in some embodiments, supplemental audio may comprise programming audio. For example, supplemental audio may comprise any of the sounds heard during a live or prerecorded sporting event, television show, movie, cartoon or the like output by a gaming device, including but not limited to the sounds of characters talking, laugh tracks, sound effects, scores, announcers, crowds, and so on.

(4) Promotional audio: In some embodiments, supplemental audio may comprise promotional messaging, which may include promotions and/or offers output on behalf of (or sponsored by) a casino or other entity. For example, in one embodiment, casino marketers may prerecord promotonal messages such that they may be output as supplemental audio to players. Promotional messages may encourage the use of one or more casino facilities, games, gaming devices, products, services, and so on (e.g., “Special offer! Get a deluxe suite in our acclaimed four-star hotel for only $45! Ask a representative to learn how”). Promotional audio may or may not be customized for the particular player to whom the promotional audio is output.

(5) Status update audio: In some embodiments, supplemental audio may comprise one or more status updates. For example, a player may be informed of a status of one or more features, bonus games, reservations, etc. In one or more embodiments, a status update may inform a player of data associated with a gaming contract or gaming session (e.g., “You have 37 spins remaining before this session expires,” “You are currently due a cash refund of $137 for this gambling loss insurance policy,” “You won 8 credits and your balance is now 85 credits,” etc.). Gaming contracts and session-based play of gaming devices are described in Applicant's pending U.S. patent application Ser. No. 10/001,089, filed Nov. 2, 2001, entitled “GAME MACHINE FOR A FLAT RATE PLAY SESSION AND METHOD OF OPERATING SAME”; U.S. Pat. No. 6,077,163, filed Jun. 23, 1987, entitled “GAMING DEVICE FOR A FLAT RATE PLAY SESSION AND A METHOD OF OPERATING SAME”; pending U.S. application Ser. No. 60/XXX,XXX, filed Aug. 10, 2004, entitled, “SYSTEMS, METHODS AND APPARATUS FOR ADMINISTERING GAMING CONTRACTS”; pending U.S. application Ser. No. 10/636,520, filed Aug. 7, 2003, entitled, “SYSTEM AND METHOD FOR COMMUNICATING GAME SESSION INFORMATION”; U.S. Pat. No. 6,113,493, filed Feb. 21, 1997, entitled, “SYSTEM AND METHOD FOR GENERATING AND EXECUTING INSURANCE POLICIES FOR GAMBLING LOSSES”; and pending U.S. application Ser. No. 10/365,154, filed Feb. 11, 2003, entitled, “METHOD AND APPARATUS FOR PROVIDING INSURANCE POLICIES FOR GAMBLING LOSSES”; the entirety of each are incorporated herein by reference for all purposes.

In one embodiment, a status update provided to a first player may be related to a second player (e.g., “Your husband has just won a $170 payout!”). In yet another embodiment, a status update may inform a player of a status associated with a wager placed elsewhere in a casino (e.g., if a player places a bet with the sports book in association with a football game, a player may be updated when the score changes in the game). In further embodiments, a status update may inform a player of new content available, such as new games, features or other updates made available for download in an environment wherein a server stores a variety of types of games or other content that may be promulgated to gaming devices. In still further embodiments, a status update may not be gambling-related, but rather may inform a player of the occurrence of some other event (e.g., “Your hotel room has just been cleaned”).

In one embodiment, status update audio or another type of audio may be output to a player via a private audio channel that comprises a cellular telephone. For example, communicating session (e.g. net balance) information to customers' cellular telephones may facilitate session play without requiring a gaming device to be modified in any manner.

In one embodiment, status update audio may include status updates on non-gambling related activities associated with a player. For example, transit (e.g., flight, bus, train, traffic) information could be provided to a player (e.g., “Your flight is delayed, so keep playing!”).

(6) Music: In some embodiments, supplemental audio may comprise music. For example, in one embodiment, a controller (or gaming device) may be configured to transmit music to a headset device. In some embodiments, it may be advantageous for a central server to maintain an inventory of music, such that storage requirements need not be burdened upon each gaming device. Music may be stored in a variety of manners, as is known in the art (e.g., a server stores a catalog of compact discs much like a conventional jukebox, a server stores a library of sound files such as MP3 files, a server or gaming device comprises an Internet connection such that music may be “streamed” from the Internet, and so on). It should be understood that such music might be further categorized by genre, artist, and so on. Thus, in some embodiments, when registering to receive music as supplemental audio, a player may indicate one or more music preferences (e.g., the player may indicate a preference of classical music). Such preference data may then be stored in a database of the present invention (e.g., a registered supplemental audio database), such that preferences may be determined when outputting supplemental audio. It should be noted that, in both embodiments in which a player registers for supplemental audio and other embodiments, a player's preference for a particular genre of music or artist may be derived from selections made by the player, without the player directly indicating such preferences.

(7) Live broadcast audio: In some embodiments, supplemental audio may comprise a live feed from a broadcast such as a radio broadcast. For example, in one or more embodiments, a player may play a gaming device while listening to a radio broadcast of a live sporting event or a live newscast. It should be noted that such audio may not necessarily be associated with audio/video programming output by a gaming device (e.g., a gaming device may output a television sitcom, though a player may listen to a broadcast of a live sporting event).

(8) Game-related audio: Game-related audio may comprise sounds associated with game play of a gaming device. For example, if a gaming device is a slot machine, game-related audio may comprise the sounds associated with game events such as the spinning of reels, payouts, the occurrence of one or more particular symbols, bonus rounds, and so on. In some embodiments, game-related audio may not be considered supplemental audio (i.e., audio that is only output to a headset or other private audio channel), and thus may be available to all players regardless of whether or not an output device comprises a headset. For example, in one embodiment, game-related audio may be output simultaneously via audio speakers and a headset device at all times.

In one embodiment, game-related audio may be categorize into two sub-categories: audio related to a primary game being played on a gaming device and audio related to a secondary game. The secondary game may comprise, for example, a bonus game conducted on the gaming device or another type of secondary game (e.g., a server enabled game that is run by a server and not by the gaming device, a secondary game that continues over several game plays, several play sessions and/or several gaming devices). In such embodiments, game-related audio that is related to a secondary game may only be output via a headset or other private audio channel (e.g., if such a channel is active) while game-related audio related to the primary game may be output, for example, via both the private audio channel and speakers the sounds of which are audible to general passersby of a casino.

(9) Foreign Language audio: in one embodiment, game-related audio and/or another type of audio may be output to a player in a foreign language. For example, if the player prefers to hear information in Chinese, the game-related or other type of audio may be output to the player in the Chinese language. Such foreign language audio may be output via a private audio channel.

Many other types of supplemental audio are contemplated and within the scope of the present invention. For example, age restricted and/or age appropriate audio may be output.

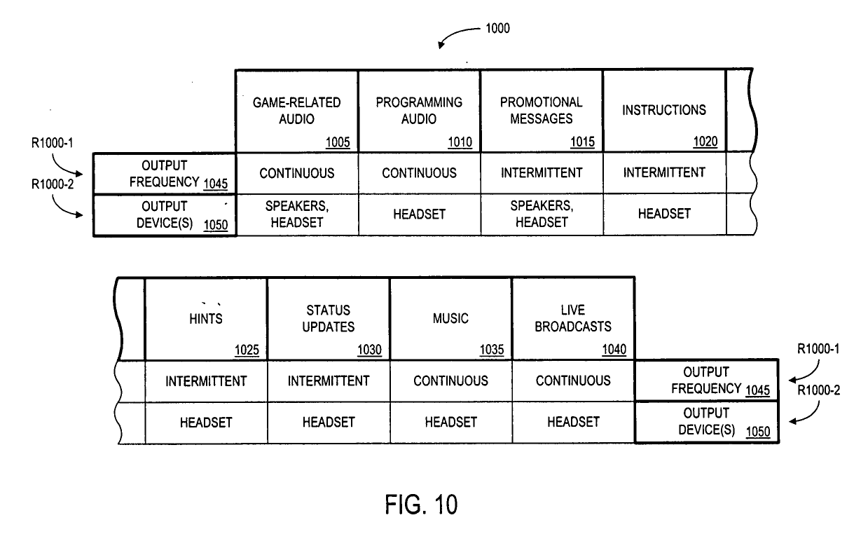

Referring now to FIG. 10, illustrated therein is a tabular representation of an example embodiment 1000 of a supplemental audio output rules database 340. Embodiment 1000 is referred to as supplemental audio output rules database 1000 herein. A supplemental audio output rules database 1000 may be stored in a memory of a device (e.g., memory 315 of controller 300 and/or memory 410 of gaming device 400) in tabular form, or any other appropriate database form, as is well known in the art. The data stored therein may include a number of exemplary records or entries, including records R1000-1 through R1000-2, each defining a supplemental type of audio. Those skilled in the art will understand that the supplemental audio output rules database 1000 may include any number of entries.

The supplemental audio output rules database 1000 may be utilized, for example, to determine a manner in which to output a particular type of supplemental audio. In some embodiments, two or more types of audio may be output simultaneously, substantially simultaneously such that the sounds of one type of audio (e.g., a primary audio) may be output at the same time that sounds of another type of audio (e.g., supplemental audio comprising hints) are being output. However, simply because the two types of audio are being output simultaneously may not necessarily mean that the two types of audio are both being output continuously. For example, the primary audio may be output continuously while the hints may only be output intermittently, as appropriate (e.g., an appropriate hint may be output at a point in a game to which the hint is relevant). In another example, a player may listen to music while receiving instructions and game-related audio and while all three types of audio may be output simultaneously at times, all three types may not necessarily be output continuously at all times. In some embodiments, the output of one particular type of audio may interrupt the output of another type of audio. For example, as indicated in FIG. 10, an output frequency (i.e., a general indication of how often sounds are emitted in association with an audio type) may be associated with a type of audio (e.g., instructions are “intermittent,” meaning they occur on a regular or irregular basis but not on a continuous basis, whereas music is “continuous”). Thus, in one embodiment, an intermittent audio type, such as a hint, may interrupt a continuous audio type, such as music.

The supplemental audio output rules database 1000 may define fields for each of the entries or records. The fields may specify: (i) an output frequency field 1045 and (ii) an audio output device(s) field 1050 for each of the following types of supplemental audio types: (i) game related audio 1005; (ii) programming audio 1010; (iii) promotional messages 1015; (iv) instructions 1020; (v) hints 1025; (v) status updates 1030; (vi) music 1035; and (vii) live broadcasts 1040.

The audio output device(s) field 1030 may store an indication of the one or more audio output devices via which each particular type of audio is to be output. The output frequency field 1050 may store an indication of a basis on which the audio output it to be output (e.g., continuously or intermittently). It should be noted that an audio being output intermittently may mean that the audio is to be output in response to an occurrence of a predetermined event (e.g., an indication from a player, an occurrence of a particular time, an occurrence of an event in a game; an occurrence of a sound in a primary audio). Of course, a different sound or portion of a particular type of supplemental audio may be output at different times (e.g., a first hint may be output upon an occurrence of a first event in a game and a second hint may be output upon an occurrence of a second event in the game).

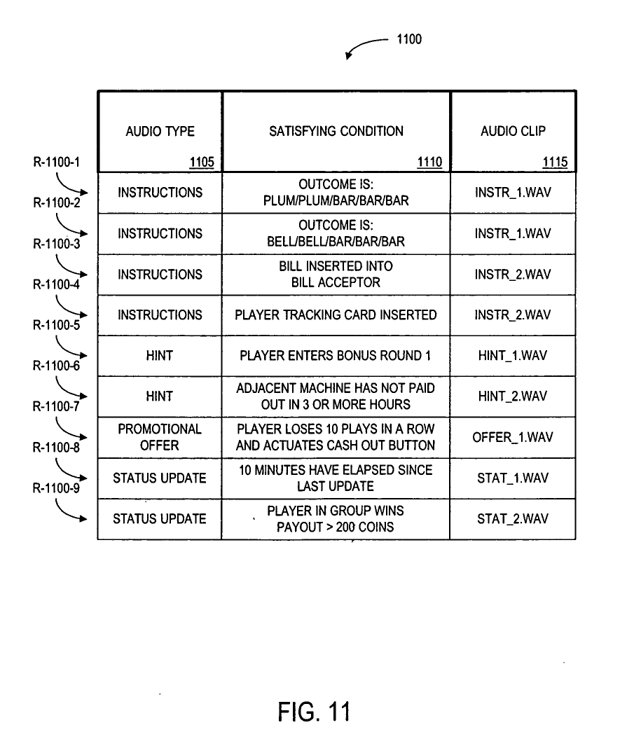

Referring now to FIG. 11, illustrated therein is a tabular representation of an example embodiment 1100 of a supplemental audio trigger database 425. Embodiment 1100 is referred to as supplemental audio trigger database 1100 herein. A supplemental audio trigger database 1100 may be stored in a memory of a device (e.g., memory 315 of controller 300 and/or memory 410 of gaming device 400) in tabular form, or any other appropriate database form, as is well known in the art. The data stored therein may include a number of exemplary records or entries, including records R1100-1 through R1100-9, each defining a trigger for outputting a supplemental audio type. Those skilled in the art will understand that the supplemental audio trigger database 1100 may include any number of entries.

The supplemental audio trigger database 1100 may be utilized, for example, to determine when to output a particular type of supplemental audio and which particular audio file to output in response to a particular trigger (e.g. in response to the satisfaction f one or more conditions associated with a particular type of audio or audio file).

The supplemental audio trigger database 1100 may define fields for each of the entries or records. The fields may specify: (i) a supplemental audio type field 1105; (ii) a satisfying condition field 1110 that indicates a condition the satisfaction of which triggers an output of a supplemental audio file; and (iii) an audio clip field 1115 that indicates an audio file to be accessed and the sounds of which are to be output upon the corresponding condition being satisfied. Of course, it should be appreciated that sources other than stored audio files may be utilized (e.g., audio broadcasts).

Referring now to FIG. 12, illustrated therein is a process 1200 that is consistent with one or more embodiments of the present invention. Process 1200 may be performed, for example, by a controller 205 and/or one or more gaming devices 210. It should be noted that, as with all processes described herein, one or more of the steps of the process may be performed by a first device (e.g., a controller 205) while another of the steps may be performed by a second device (e.g., a gaming device 210). Process 1200 may be characterized as a process for outputting audio via a private audio channel once it is determined that the private audio channel is active. It should be noted that in other embodiments audio may be output via a private audio channel irrespective of whether a private audio channel is active and/or without determining whether a private audio channel is active.

Referring now to step 1205, a first type of audio is output via a speaker of a gaming device. As described herein, a speaker is one example of an audio output element of a gaming device via which audio may be output such that the sounds of the audio are audible to general passersby of the gaming device. Various methods of outputting a first type of audio via a speaker of a gaming device have been described herein with respect to process 100 (FIG. 1) and need not be repeated herein.

In step 1210, it is determined whether a headset (or other audio output element operating as a private audio channel) is active. Determining whether a headset is active may comprise many different subroutines, depending on the embodiment(s) implemented.

In some embodiments, a headset may be permanently or semi-permanenty attached to, wired to or otherwise associated with a gaming device. For example, as described, a headset may comprise a cable, cord or wire attached externally to the cabinetry of a gaming device. Such a cable may additionally be connected internally to a gaming device processor (e.g., such that an audio signal may be sent to the headset). In one embodiment, a gaming device may comprise a means for storing such a “stationary headset” when it is not being used (e.g., such that the headset device is not left “dangling” by a player who no longer desires to use it). For example, a headband of a headset device may be rested upon a hook on the side of a slot machine (as shown in FIG. 5), or the entire device may be placed in a storage compartment when not in use. Thus, in some embodiments, such a stationary headset device may not be transferable from a first gaming device to a second gaming device.

In embodiments in which a headset is permanently or semi-permanently attached to or otherwise associated with a gaming device, there may not be a need to determine whether the headset is active, as the headset may always be considered to be active unless it is malfunctioning. Of course, in other embodiments in which a headset is permanently or semi-permanently associated with a gaming device, there may still be a need to determine whether a headset is active. For example, the headset may have an on/off switch and determining whether the headset is active may comprise determining whether the headset has been turned on.

In some embodiments, determining whether a headset is active may comprise determining whether a headset may be activated for a player. Determining whether a headset may be activated for a player may comprise, for example, whether a player qualifies for output of supplemental audio via the headset (in embodiments in which a player must qualify for supplemental audio before having such output to the player). Many different manners in which a player may qualify for output of supplemental audio are described herein (e.g., whether the player has. paid for or provided means of payment for supplemental audio, whether a player has registered for supplemental audio, whether a player has engaged in a qualifying activity, etc.).

In some embodiments, supplemental audio may be continuously output via a headset that is permanently or semi-permanently associated with a gaming device, irrespective of whether the headset is active or not. For example, supplemental audio may be broadcast from a central location (or by the gaming device itself) to all headsets that are part of the system, without regard as to whether any of the headsets are active or in use.

In some embodiments, determining whether a headset is active or not may comprise determining whether or not an “activation process” has been completed such that audio (e.g., supplemental audio) may be output to the headset. An activation process may comprise, for example, a player (i) turning on the headset, (ii) selecting output of supplemental audio, (iii) selecting a particular type of supplemental audio, (iv) initiating play on the gaming device, (v) providing payment or means of payment for the supplemental audio, and/or (vi) or registering to use a headset and/or receive supplemental audio. In another example, an actvation process may include receiving a code or other authorization from another device and/or casino personnel.

In other embodiments, a headset may comprise a “mobile headset.” As described above, a mobile headset may be transferable from a first gaming device to a second gaming device. Several examples of mobile headsets are contemplated (e.g., a commercially available model of a headset device substantially similar to one described above).

For example, in one or more embodiments, a cable of a non-wireless mobile headset may be connected to an external headset connector (e.g., a ⅛″ headphone jack or USB port) of a gaming device, as shown by FIG. 5 (e.g., a player approaches a gaming device and inserts a ⅛″ stereo connector into an appropriate jack on the front of the gaming device). Such a gaming device may then be configured to detect the mobile headset (e.g., a gaming device processor recognizes that a “hot swappable” headset has been connected via a USB port, as is known in the art). It should be noted that one advantage of such an embodiment is that gaming device players may utilize their own personal headset devices in accordance with the present invention, as such headsets are commercially available and in many instances widely owned (e.g., a player may bring a pair of stereo earphones from home and connect them to a slot machine). Thus, in one example, if a player connects a headset via an external headset connector of a gaming device, it may be determined that a headset is active in step 1210 upon detecting that a mobile headset has been associated with the gaming device. Of course, in some embodiments, a mobile headset being associated with or plugged into a gaming device may be insufficient for determining that the headset is active. For example, a further determination of whether the player qualifies for output of supplemental audio via the headset may be performed.

In some embodiments, determining whether a headset is active may comprise receiving an identifier associated with a mobile headset. For example, in one or more embodiments, a non-wireless mobile headset may comprise a memory, which may store a unique alphanumeric headset identifier (e.g., an alphanumeric code such as “H-000102”). Accordingly, a gaming device 210 and/or controller 205 may receive the identifier from the headset. In one example, a headset identifier may be transmitted from a headset connected to a USB port of a gaming device.

In some embodiments, a gaming device 210 and/or controller 205 may be operable to detect a mobile headset by receiving a headset identifier wirelessly. As described, in some embodiments, a gaming device may comprise or otherwise communicate with a base receiver unit. Accordingly, in one example, the base receiver unit may emit a radio frequency field. A wireless mobile headset may then comprise (i) a memory, which may store a unique headset identifier, and (ii) a transponder, such that the identifier may be transmitted to a receiver when the transponder enters the field emitted by the receiver. Such radio frequency identification (RFID) transmissions are known in the art and need not be detailed further herein. In some embodiments, determining whether a headset is active (e.g., step 1210) may comprise receiving an identifier associated with a wireless mobile headset.

In some embodiments, a player or casino representative may provide a headset identifier manually. In one or more embodiments, a player may enter a headset identifier using an input device of a gaming device (e.g., a player enters “H-000204” using a touch-sensitive display screen). Thus, a player may enter an identifier associated with a mobile headset, such that a gaming device 210 and/or controller 205 may determine whether the identified headset is active (e.g., a player with a wireless headset may approach a gaming device and enter a headset identifier, such that a gaming device and/or controller may then output audio wirelessly to the identified headset). In another embodiment, a player may provide a player identifier in lieu of or in addition to a headset identifier (e.g., a record of a headset database, such as the one described with respect to FIG. 8 may indicate that a player identifier is associated with a headset identifier, such that when a player enters a player tracking card into a card reader device, a controller or gaming device may determine that a headset device is associated with the player).

Thus, in some embodiments, receiving a headset identifier of a mobile headset may be part of the process of determining whether a headset is active. For example, a headset database such as the one described in FIG. 8 may be accessed upon receiving the headset and/or player identifier in order to determine whether the headset has been properly registered and/or whether a type of supplemental audio has been registered in association with the headset.

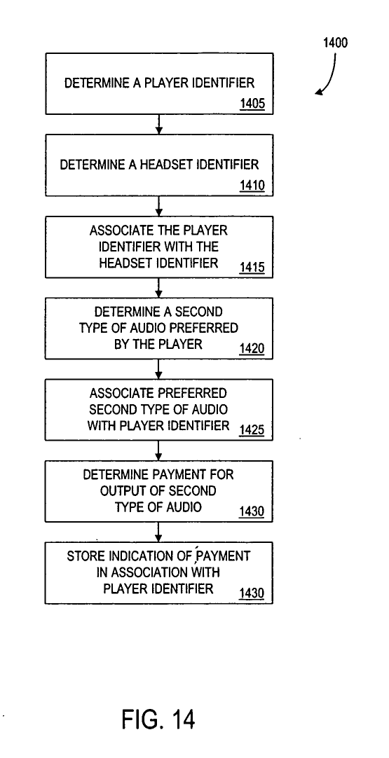

In some embodiments, a registration process, activation process and/or validation process may occur before it is determined that a headset is active. Such processes are described in detail with respect to FIG. 14, below. Thus, in at least one embodiment, determining whether a headset is active may comprise any or all of: (i) registering a headset, (ii) registering one or more types of supplementary audio, (iii) detecting a mobile headset, (iv) receiving a headset identifier, (v) receiving a player identifier, (vi) receiving an activation request, and/or (vii) determining whether or not a headset is registered. It should be understood that in some embodiments, various processes, such as a registration process, activation process and/or validation process may not occur (e.g., a player may activate a stationary headset and receive supplementary audio without registering the headset device).

If it is determined, in step 1210, that the headset is active, the process 1200 continues to step 1215. Otherwise the process returns to step 1205.

In step 1215, a second type of audio or second audio (e.g., to be output via a private audio channel) is determined. As described, in one or more embodiments a plurality of types of supplemental audio are available for output. In such embodiments, step 1215 may comprise determining which of the plurality of supplemental audio types to output. Such a determination may be performed, for example, based on a player selection at the time of the determination, based on a selection or registration by the player that occurred prior to the current determination and/or on behalf of the player (e.g., randomly, based on a game the player has selected to play or other information associated with the player, based on a schedule determined by the casino, etc.). In one embodiment, step 1215 may comprise accessing a registered supplemental audio database (such as the one described with respect to FIGS. 9A and 9B) to determine the type of supplemental audio the player currently playing the gaming device has registered for. If the player has registered for more than one type of supplemental audio, the player may be prompted to select one or more of the registered types of supplemental audio for current output. In other embodiments, one of the registered types of supplemental audios may be selected on behalf of the player. In yet other embodiments, all of the registered types of supplemental audios may be output to the player (e.g., one at a time, on a rotational basis). In other embodiments, a player may not pre-register for supplemental audio but may instead be presented with a menu of available types of supplemental audio (e.g., a menu such as that illustrated in FIG. 6) and may make a selection therefrom.

In some embodiments, process 1200 may further comprise determining a manner in which alter the audio being output by a gaming device. For example, as described above, output of the first type of audio may be interrupted or duplicated for output via the headset such that it is output in conjunction with the second type of audio via the headset. In various embodiments, altering the audio output by a gaming device may comprise (i) outputting supplemental audio (i.e., an audio signal that otherwise may not have been provided, such as “hints” or instructions only available to gaming device players utilizing headsets), (ii) selecting an audio output element association with a supplemental audio type, such as by determining to output a first audio type (e.g., a sound that accompanies coins falling) via a first audio output element (e.g., audio speakers), and to output a second audio type (e.g., the sound of a character speaking) via a second audio output element (e.g., a headset), and/or (iii) adjusting an audio parameter (e.g., a volume level), which may be based on player preferences. In one embodiment, adjusting an audio parameter may include translating audio from English into another language. Some embodiments will now be described in further detail.

As stated, in some embodiments, altering the audio output by a gaming device may comprise outputting supplemental audio (i.e., audio that is output via a private audio channel, such as a headset).

In one such embodiment, supplemental audio may be available to all players, regardless of whether or not a registration process has occurred or whether a player has somehow qualified for the output of the supplemental audio. For example, each gaming device of a casino floor may comprise a stationary headset, which may be activated at will by players as described. When activated, supplemental audio may then be output via the headset. For example, in this manner, all players wanting to hear music while they gamble may do so without hampering the enjoyment of nearby players (who may not desire to hear music). It should be noted that in one example of such an embodiment, game-related audio may always be output via both audio speakers the sounds of which are audible to general passersby and a headset while the supplemental audio only via the headset. In this manner a player wearing a headset may hear both music and game sounds, while only game sounds may be output by gaming device speakers, thus preserving the traditional din of a casino floor.

In other embodiments, one or more types of supplemental audio may only be available to players who have completed a registration process as described. In various embodiments, a player may be entitled to receive one or more types of supplemental audio if the player has (i) rented, borrowed, or purchased a headset device (e.g., the player rented a headset device for $10/hour and is thus entitled to receive all types of supplementary audio), (ii) registered for a specific type of supplemental audio (e.g., the player paid $5 to receive three hours of hints), (iii) signed up for a player tracking card, and/or (iv) otherwise qualified for output of supplemental audio. As described herein, an indication of whether a player has qualified for output of one or more types of supplemental audio by virtue of registering therefore may be stored in a registered supplemental audio database such as the one described with respect to FIGS. 9A and 9B (e.g., the database indicates whether or not a particular type of audio is “registered” or “unregistered,” the database indicates a date/time until which the particular type of audio is registered, etc.). In one embodiment, a player may indicate a date and/or time during which one or more types of supplemental audio are to be output (e.g., when registering, a player indicates that music is to be output until noon, and that live programming should be output thereafter).

As described, in some embodiments a player may identify one or more types of supplemental audio to be output. The player may provide such a selection before and/or during a gaming session. For example, a player may indicate a type of supplemental audio by actuating an input device of a gaming device (e.g., the player presses a button labeled “Play Music”). In another example, a player may access a menu indicating available types of supplemental audio (e.g., a player presses a graphic of a touch-sensitive display screen labeled “audio Menu,” and the display screen subsequently depicts choices such as “Music,” “Hints,” “Status Updates” and so on). Such a menu, an example of which is depicted in FIG. 6, may also allow players to select different options within a particular selected type of supplemental audio (e.g., a player may select a genre of music or a particular live broadcast from a list of live broadcasts). It should be noted that such embodiments may also be beneficial in that players can select different types of supplemental audio during gaming sessions. For example, a player may listen to music for a period of time, and then switch to instructions. In another example, a player may request instructions or a status update (e.g., a player presses a button labeled “Instructions,” and then presses a button labeled “Why didn't I win?”).

In step 1220, a second type of audio (or second audio) determined in step 1215 is output via the headset determined to be active in step 1210. As described above, outputting the second type of audio may comprise a processor operating in conjunction with a sound card to output an audio signal to an audio output element configured to operate as a private audio channel. As also described, outputting the second type of audio may comprise outputting both the first type of audio (that is being output via speakers the sounds of which are audible to general passersby) and the second audio type via the headset or other private audio channel. Various methods of outputting both types of audio may be employed. For example, the sounds of the two types of audio may be intermingled, combined, mixed, integrated or otherwise configured for output via the private audio channel during a particular gaming session.

As described above (especially with respect to FIG. 10), some types of supplemental audio may be output on a continuous basis while others may be output on an intermittent basis. In some embodiments, various triggers (e.g., conditions to be satisfied in order for the corresponding supplemental audio to be output) may be associated with an intermittent audio type, such that should a satisfying condition occur, the supplemental audio or appropriate portion of the supplemental audio may be output. In one example of such an embodiment, an audio trigger database (an exemplary data structure of which is depicted in FIG. 11) may be used. For example, turning to FIG. 11 and records R1100-1 and R1100-2, if a slot machine player achieves an outcome of “plum/plum/bar/bar/bar” or “bell/bell/bar/bar/bar” on a five-reel slot machine, an associated stored audio clip named “instr_{—}1.wav” (the .wav file format being an example, though other methods of storing audio are contemplated) may be output. Such an audio clip may inform the player, for example, “You got three bar symbols in a row, but they were aligned to the right. They must be aligned to the left for a payout to occur”. In another example, if a player inserts a tracking card or a bill, an appropriate audio clip may be output (e.g., the clip indicates “Press the flashing spin button to begin”). In yet another example, if a player enters into a bonus round, an appropriate audio clip may be output (e.g., “75% of players choose the box on the right,” “The box on the right contains X credits,” etc.). In yet another example, if an adjacent gaming device has not paid out (e.g., any coins, any payout larger than 10 coins, etc.) in a particular period of time (e.g., three hours), an appropriate audio clip may be output (e.g., “The machine to your right is due to pay out!”). In yet another example, if 10 minutes have elapsed during a gaming session, a player may be provided with a status update (e.g., “You are currently due a cash refund of $17.25 for this gambling loss insurance policy”). In yet another example, if two players are associated with one another (e.g., the players join a “status update group” when registering headsets), a first player may receive an update if a second player achieves a payout greater than a threshold amount of coins. It should be understood that in some embodiments, players may only receive audio clips if they have registered for an associated supplemental audio type. Thus, for example, if a player achieves an outcome of “plum/plum/bar/bar/bar” but has not registered or otherwise selected to receive instructions, no audio clip may be output.

In some embodiments, process 1200 may comprise a gaming device 210 and/or a controller 210 tracking supplemental audio output to a player. For example, if a player is entitled to six hours of music, a timer mechanism may be initiated when the player firsts requests to hear music, such that when the time expires, a registered supplemental audio database or other database may indicate that the player is no longer entitled to hear music (e.g., a field of the registered supplemental audio database depicted in FIGS. 9A and 9B in a record associated with the player indicates that the player is “unregistered” for the music once the six hours are used up by the player). It should be noted that, in some embodiments, the output of supplemental audio may occur over the course of several gaming sessions, days, etc. (e.g., such that if a player listens to one hour of music on a first day, and another two hours of music on a second day, a database may reflect that the player has listened to three hours of music).

In some embodiments, determining a second type of audio may further comprise determining an audio output element via which the second type of audio is to be output. For example, in some embodiments, upon determining in step 1205 that a headset is active, a gaming device 210 and/or controller 205 may determine that a first type of supplemental audio should be output via a first audio output element and a second type of supplemental audio should be output via a second audio output element. In one such example, a gaming device may be operable to output at least two types of audio (e.g., game-related audio and programming audio). In such embodiments, the gaming device may be operable to, at times (e.g., when a headset or other private audio channel is not active), output all or a subset of the types of audio output via a first audio output element such as audio speakers the sounds of which are audible to general passersby of the gaming device. At other times (e.g., once a headset is activated) the gaming device may modify the audio output such that a first audio type (e.g., game-related sounds) is output via a first audio output element (e.g., speakers) and a second audio type is output via a second audio output element (e.g., a headset). In some embodiments, a supplemental audio output rules database (e.g., such as the one depicted in FIG. 10) may be accessed when making such a determination. For example, such a database may indicate one or more audio output elements association with a particular type of supplemental audio, such that a particular type of supplemental audio may only be output to a particular audio output element if the audio output element is indicated by the database (e.g., programming audio may only be output via a headset, whereas game-related audio may be output via either speakers, a headset or both). Accordingly, in one example, step 1220 or another step of process 1200 may comprise determining to output game-related audio via both a headset and audio speakers, as well as determining to output programming audio via only a headset. It should be understood that in some embodiments, certain types of supplemental audio may be considered premium, and thus may only be made available to certain players (e.g., players who have completed a registration process).

Thus, in some embodiments, determining a manner in which to alter the audio output by a gaming device may comprise selecting an audio output element associated with the second type of supplemental audio determined in step 1215.

In one embodiment, step 1220 or another step of process 1200 may comprise adjusting an audio parameter. For example, if a headset is determined to be active in step 1210, step 1220 or another step of process 1200 may comprise adjusting a volume level. In some embodiments, a volume level may be associated with a particular audio type (e.g., if an audio output element comprises a headset, a volume level associated with music may be increased). In other embodiments, a volume level may be associated with an audio output element (e.g., all audio output via audio speakers should be decreased). In some embodiments, a volume level may be adjusted based on player preferences (e.g., as indicated by a player database or another database, a player may indicate a desired volume level in association with one or more types of audio when registering for a headset and/or audio). In other embodiments, a volume level may be adjusted based on another factor (e.g., if a headset is determined to be active in step 1210, step 1220 may comprise reducing the volume level of game-related audio by 4 decibels).

In other examples, if it is determined in step 1210 that a headset is active, step 1220 or another step of process 1200 may comprise adjusting other audio parameters based on player preferences. For example, when registering for a headset and/or a type of supplemental audio, a player may not only register to receive music as a type of supplemental audio, but may also indicate a preferred genre of music (e.g., the player prefers rock music). In another example, if a player has signed up to receive instructions, the player may indicate a preferred language in association with the instructions (e.g., such that both English-speaking and Spanish-speaking players may be accommodated). In a further example, a player may indicate various kinds of promotional messages with the player would like to hear (e.g., “Tell me about buffet specials”). Thus, in one or more embodiments, step 1215, step 1220 and/or another step of process 1200 may comprise both (i) determining a type of supplemental audio to be output, and (ii) altering, determining or selecting an audio parameter in association with the supplemental audio (e.g., a language, volume level, type of music, etc.).

In further embodiments, step 1220 may comprise outputting a second type of audio via a device other than a headset. For example, as described, audio may be output using ultrasonic sound technology, such that only a listener in a particular area or field in relation to an ultrasonic speaker may hear the audio.

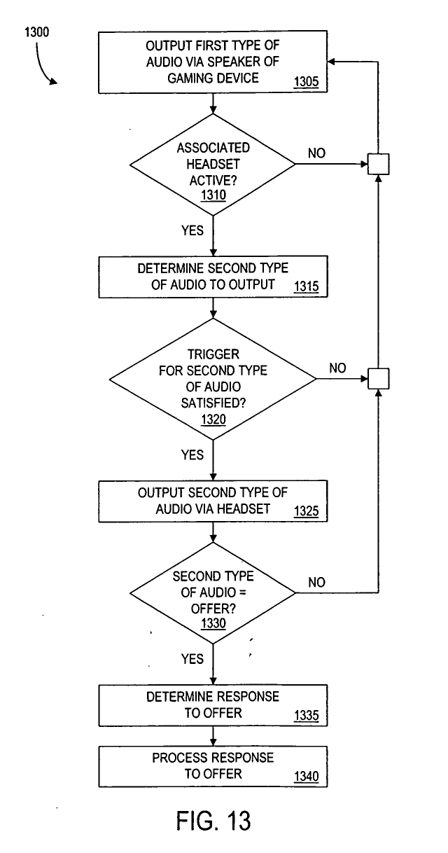

Referring now to FIG. 13, illustrated therein is a process 1300 for outputting a supplemental audio that is a promotional offer, such that a response from a player to the supplemental audio is determined and processed.

In step 1305, a first type of audio is output via a first audio output element of a gaming device (e.g., via a speaker the sounds of which are audible to general passersby of a gaming device). Outputting a first type of audio via a first audio output element of a gaming device has been described in detail herein (e.g., with respect to step 1205 of FIG. 12) and need not be repeated.

In step 1310 it is determined whether a headset associated with the gaming device is active. Again, determining whether a headset is active has been described in detail herein (e.g., with respect to step 1210 of FIG. 12) and need not be repeated herein. If it is determined that an associated headset is active, the process 1300 continues to step 1315. Otherwise, the process 1300 returns to step 1305.

In step 1315 a second type of audio for output is determined. Determining a second type of audio (e.g., supplemental audio) for output is described in detail herein (e.g., with respect to step 1215 of FIG. 12) and need not be repeated herein.

In step 1320 it is determined whether a trigger associated with the second type of audio is satisfied. As described herein, in one or more embodiments a supplemental audio may be output on an intermittent basis, such as upon a condition associated with the supplemental audio (or portion or file thereof) being satisfied. Such a condition may be characterized as a trigger for output of the supplemental audio herein. For example, the supplemental audio trigger database of FIG. 11 stores various triggers associated with various respective audio files associated with various types of supplemental audio. Accordingly, in one embodiment step 1320 may comprise determining whether a condition associated with output of the type of supplemental audio determined in step 1315 has been satisfied. In one embodiment, step 1320 may comprise determining whether a signal from another device has been received, the signal indicating that such a condition has been satisfied.

If a trigger for the second type of audio has been satisfied, the process 1300 continues to step 1325. Otherwise, the process 1300 returns to step 1305.

In step 1325 the second type of audio is output via the headset determined to be active in step 1310. For example, the audio file or portion of audio file associated with the condition determined to be satisfied may be output. In a more particular example, a database such as the supplemental audio trigger database of FIG. 11 may be accessed and the sounds of the audio file corresponding to the satisfied condition may be output via the headset. Many other methods of outputting the second type of audio are described herein (e.g., with respect to step 1220 of FIG. 12) and need not be repeated herein.

In step 1330 it is determined whether the second type of audio comprises an offer to which a response is expected. As described herein, in some embodiments supplemental audio may comprise promotions or promotional offers (e.g., for products, services, discounts, etc.). Such promotional offers may be sponsored, for example, by a casino or other entity. An offer may be in the form of a query (e.g., “Would you like to purchase discounted tickets to the casino's premier show for this evening?”; “Would you like to extend your gaming contract?”; “Was the waitress polite to you?”; “Would you like a free night's hotel stay in lieu of the payout you just won?”). As such, response may be required from a player before the output of the offer is considered complete. If the second type of audio is an offer to which a response is expected, the process 1300 continues to step 1335. Otherwise, the process 1300 returns to step 1305.

In step 1335, it is determined whether a response to the offer has been received. For example, it may be determined whether a player actuated a button (e.g., a mechanical button on the cabinet of the gaming device or a virtual button on a touchscreen of the gaming device). In one embodiment, a headset and/or gaming device may be equipped with a microphone into which a player may speak a response to an offer and such speech may be recognized and processed to determined the response. In one embodiment, a lack of response (e.g., the player does not respond within one minute of the output of the offer or within another predetermined time period) may be recognized as a rejection of the offer.

In step 1340 the response to the offer is processed. For example, the response may be forwarded to another device (e.g., a controller 205). In another example, the response may be stored in a database for further processing. In yet another example, an event may be initiated at the gaming device as a result of the response. For example, if the player accepted an offer in exchange for which the player is to receive a payment, the gaming device may provide the payment to the player in the form of credits added to the credit meter balance of the gaming device or a ticket printed via a printer device of the gaming device. In another example, if the player accepted an offer to accept a contract, one or more parameters of a contract may be reset and/or implemented (e.g., the number of game plays due a player under the contract may be reset). In yet another example, if the player accepted an offer for a product (e.g., a ticket to a show at the casino), the ticket (or a receipt therefore) may be printed at the gaming device or a casino employee may be instructed to bring the ticket to the player. In yet another example, if the player accepted an offer for which payment is required from the player, the payment may be collected from the player (e.g., credits may be deducted from a credit meter balance of the gaming device, a financial account associated with the player may be charged, the player may be prompted to insert payment into the gaming device, etc.).

Referring now to FIG. 14, illustrated therein is a process 1400 that is in accordance with one or more embodiments of the present invention. The process 1400 may be characterized as a registration process for registering a player for a headset and/or one or more types of supplemental audio.

As described herein, some embodiments may comprise a headset registration process. In some embodiments, a casino may provide a headset to a gaming device player. Headsets may be provided in a variety of manners. In one embodiment, casinos and/or other entities may sell, rent, lend or otherwise provide access to headsets to gaming device players. In some embodiments, headsets may be rented or borrowed for a period of time and/or for a fee. Thus, some embodiments may comprise a headset registration process wherein players register to use a headset and/or for output of one or more types of supplemental audio.

In some embodiments, a registration process may comprise (i) determining a rental period (e.g., a period of time during which a headset device is registered for use), (ii) receiving a purchase payment or rental payment (e.g., a fee paid by a player such that the headset device may be rented for a period of time), and/or (iii) recording a registration status in association with a headset identifier and/or player identifier (e.g., a casino representative using a computer device enters data such that a field of a headset database is changed from “unregistered” to “registered”).

As stated, in some embodiments, a player may purchase a headset device, and thus no rental period may be determined (e.g., a no “rental period end” date is recorded in a headset database in association with the headset). In other embodiments, a player may rent a headset device from a casino. A headset rental may be facilitated in a variety of manners. In one embodiment, a player may rent a headset from a central casino location, such as a “player's club” booth or desk within a casino. Such a desk may be staffed with personnel and stocked with headsets. In some embodiments, each headset may comprise a headset identifier (e.g., an alphanumeric code stored in the headset's memory). In one such embodiment, a headset identifier may be indicated externally (e.g., a sticker indicating the identifier is adhered to a headset). In some embodiments, a rental fee may be determined in accordance with a rate schedule (e.g., headsets may be rented for $5/hour). Accordingly, should a player provide a rental fee (e.g., the player tenders a cash payment of $5 to a casino representative), a registration status may then be recorded in association with a headset identifier and/or player identifier. For example, a casino representative may enter data using a computer device, such that a registration status field of a headset database reflects that an identified headset device is registered, and that a “rental period end” associated with the headset device is recorded (e.g., a “rental period end” is one hour from the current time). Thus, in some embodiments, when a headset identifier is received by a gaming device 210 and/or controller 205, it may be determined whether or not the identified headset is registered. If the identified headset is registered, it may be determined that the headset is active or otherwise available for output of supplemental audio.

In one embodiment, a player may rent, borrow, purchase or otherwise obtain access to a headset device that may not be uniquely identified (e.g., a set of stereo earphones that comprise no memory). Accordingly, in some embodiments, a headset registration status may be associated only with a player identifier (e.g., a registration status field associated with a player identifier indicates that a registered headset is associated with a player but does not identify a particular headset uniquely). Thus, when a player is identified by a gaming device 210 and/or controller 205 (e.g., the player inserts a player tracking card into a card reader device), it may be determined that a headset is registered to a player. Accordingly, it may then be determined that a headset device is active or otherwise available for output of supplemental audio to a player.

Thus, it should be noted that if a headset is unregistered (e.g., the player did not pay a fee to rent the headset device or otherwise arrange to use the headset) or expired (e.g., as indicated by a record of a headset database, the date/time associated with a rental period end elapses and thus a registration status indicates that a headset device is “expired”), it may be determined that a headset is not active or is otherwise not available for output of supplemental audio.

In further embodiments, a player may pay a supplemental audio fee in lieu of or in addition to paying a headset rental fee. A supplemental audio fee may be based on the supplemental audio content (e.g., hints, instructions) that a player may desire to hear through the headset while playing one or more gaming devices. For example, a player may desire to hear one hour of hints, and may thus be required to pay a supplemental audio fee of $8. In another example, a player may desire to hear one hour of instructions as well as an hour of music, and may thus be required to pay a supplemental audio fee of $12.

Thus, in at least some embodiments, various types of supplemental audio may be available to a player, and various fees may be associated with one or more types of supplemental audio. For example, in one embodiment, instructions cost $8 per hour, whereas music may cost $4 per hour. In another embodiment, a player purchasing, renting or otherwise arranging to use a headset may be entited to unlimited supplemental music. In yet another embodiment, a player may pay a fee such that all types of supplemental audio may be accessed (e.g., as is described in more detail herein, a player may access a menu presenting various supplemental audio choices). In yet another embodiment, a player who rents, purchases, borrows or otherwise arranges to use a headset may be automatically registered for one or more types of supplemental audio (i.e., in some embodiments, no fee may be associated with one or more types of supplemental audio).

Accordingly, in some embodiments, a registration process such as process 1400 may comprise registering one or more types of supplemental audio in association with a headset identifier and/or player identifier. In various embodiments, a player may register for one or more types of supplemental audio, and such registration data may be reflected in a registered supplemental audio database (e.g., such as the one depicted in FIGS. 9A and 9B). Stored supplemental audio registration data may indicate a period of time for which a registration may last. For example, a registration may last (i) for a specified duration of time (e.g., a player may purchase “6 hours” of hints), (ii) until a certain time/date (e.g., a player may register to hear music until February 15^{th} at 9:51 a.m.), (iii) permanently (e.g., a player and/or headset may be considered permanently or semi-permanently “registered” in association with a particular type of supplemental audio). In one embodiment, a casino representative may enter such supplemental audio registration data (e.g., using a computer in communication with a controller 205) such that a supplemental audio database may be populated appropriately (e.g., a customer who purchases an hour of instructional audio may receive instructions, because a supplemental audio database indicates the player is entitled to receive the particular type of supplemental audio). In some embodiments, a player may be automatically registered for one or more types of supplemental audio (e.g., by virtue of purchasing, renting, borrowing or otherwise arranging to use a headset). In other embodiments, a player may indicate (e.g., verbally to a casino representative, by filling out a form, etc.) one or more desired types of supplemental audio.

In this manner, process 1400 may comprise a headset registration and/or supplemental audio registration process. Turning again to FIGS. 9A and 9B, a variety of examples of results of such a registration process are illustrated. In one example, a player “P-000550” may purchase a headset, and thus may be permanently registered to receive supplemental audio associated with audio/video programming, promotional messages, and instructions. In another example, a player “P-001687” may rent a headset “H-000002,” and thus be registered to receive (i) unlimited audio associated with audio/video programming, (ii) unlimited promotional messaging, (iii) instructional audio for the next two hours, and (iv) music for the next two months. In a third example, a player “P-000741” may be permanently registered to receive status updates and music, but may only have access to live broadcasts until 7:51 p.m. In a fourth example, a player “P-002922” may register for six hours (e.g., the time may not be used all in the same day) of hints and instructions (e.g., the player joins a “Player's Edge: Hints and Instructions” club). As described herein, in some embodiments, individual fees/rates may be associated with one or more types of supplemental audio. Further, as stated, it should also be understood that such supplemental audio data may be associated with a player identifier and/or a headset identifier, such that the data may be accessed before outputting supplemental audio (e.g., to determine, in accordance with one embodiment, whether a player qualifies for output of supplemental audio by virtue of being registered for the supplemental audio).

In some embodiments, during a registration process such as process 1400 or during another process, a player may indicate one or more general audio preferences. For example, a player may indicate a desired headset volume level. In another example, if a player is eligible to receive supplemental audio, a player may indicate a preferred time during which a type of supplemental audio should be output (e.g., play classical music from 5 p.m. until 8 p.m.). In a third example, if a player is eligible to receive promotional messages, the player may indicate that the player does not desire to hear such messages. Such preferences may be stored in one or more databases (e.g., a player database, a registered supplemental audio database and/or another database). In this manner, preferences of a player for output of supplemental audio may be considered when a manner in which to alter the audio output of a gaming device is being determined.

Some embodiments may include a headset activation process, which may or may not be a distinct process from a registration process such as process 1400 (e.g., performed in addition to, in conjunction with or in lieu of the registration process 1400). A headset activation process may comprise, for example, receiving an indication from a player that at least one type of supplemental audio is to be output to a headset. As described herein, in some embodiments, a headset may comprise a stationary headset (e.g., a headset that is attached to a slot machine). Thus, a player may be given an opportunity to activate a stationary headset. For example, a player may approach a gaming device that (i) incorporates audio/video programming in a manner similar to those previously described, and (ii) comprises a stationary headset. Thus, a player may desire that certain types of supplemental audio (e.g., programming audio, such as dialogue) be output via a headset. Accordingly, an input device may allow the player to “activate” the stationary headset device. For example, a player may press a physical button labeled “activate headset” such that a gaming device 210 and/or controller 205 may be instructed to output supplemental audio to a headset. In another example, a player may press an area of a touch-sensitive display screen indicating “Press here to use headset.” Thus, a gaming device may receive from a player a request to activate a stationary headset.

In another embodiment, a gaming device 210 and/or controller 205 may detect a mobile headset as described. For example, a gaming device may detect that a headset has been connected via a USB port. Accordingly, the gaming device may be configured to output an activation prompt via a display device (e.g., a touch-sensitive display screen), which may provide a player with an opportunity to activate the connected headset (e.g., “You have connected a headset. Press “OK” to activate this headset.”). In another example, a gaming device 210 and/or controller 205 may detect a wireless headset as described, and accordingly output an actvation prompt. Further, a gaming device may output a prompt to activate a stationary or mobile headset after identifying a player (e.g., after a player inserts a tracking card, a player database is accessed to determine whether or not a headset and/or supplemental audio is registered in association with the player, and if so, an activation prompt such as “Would you like to use a headset?” may be output). Further, in some embodiments, such an “activation status” may be recorded in a headset database of the present invention (e.g., such that headsets which are not being used are considered “inactive” while headsets in use appear as “active”) once a player activates a headset.

In some embodiments, a player who qualifies to receive supplemental audio may identify one or more types of supplemental audio to be activated. For example, upon receiving an activation request from a player as described (e.g., a player presses an “activate headset” button), a gaming device may output a menu detailing various types of supplemental audio which may be individually activated. An example of one embodiment of such a menu is described in further detail with respect to FIG. 6.

In some embodiments, a fee may be associated with the activation of a headset and/or particular type of supplemental audio. For example, a player may pay a first fee to register (e.g., rent) a headset, and then a second fee each time the headset is subsequently activated (e.g., each time the player begins a gaming session at a gaming device). In another example, a player may receive a headset for free, though each time the player activates a particular type of supplemental audio, the player may be assessed a fee.

Some embodiments may include a validation process, which may or may not be a distinct process from a registration process such as process 1400 (e.g., performed in addition to, in conjunction with or in lieu of the registration process 1400). A validation process may comprise (i) receiving a headset identifier, (ii) receiving a player identifier, (iii) detecting a mobile headset, (iv) receiving a request to activate a headset and/or type of supplemental audio, and/or (v) determining whether or not a headset and/or type of supplemental audio is registered. Thus, if it is determined that a headset device and/or type of supplemental audio are registered, the desired supplemental audio may be determined and output via the headset. In one example of a validation process, a gaming device 210 and/or controller 205 may access a headset database based on a player identifier “P-000075” (e.g., the player may have provided a player tracking card, connected a set of stereo earphones via a ⅛″ audio jack, and requested that the headset be activated) and determine that a registration status associated with the player, as it relates to the headset, is “registered.” In another example, a gaming device 210 and/or controller 205 may access a headset database based on a headset identifier “H-000002” and determine that the device is “unregistered” (and accordingly, not allow the headset to be used or not authorize output of supplemental audio via the headset). In yet another example, a gaming device 210 and/or controller 205 may access a headset database based on a headset identifier “H-000003” and determine that a registration status is “expired” (e.g., a two-hour rental period for which a player paid a fee has concluded), and thus not allow the a headset be used or not authorize supplemental audio to be output via the headset. In yet another example, a gaming device 210 and/or controller 205 may access a player database (e.g., as depicted by FIGS. 7A and 7B) and determine that a registered headset identifier is associated with a player identifier “P-106998” (and accordingly, allow the headset to be used or authorize supplemental audio to be output via the headset).

Referring now to the particular steps of process 1400, in step 1405 a player identifier is determined. For example, a player may provide a player identifier to a gaming device, kiosk, casino personnel or otherwise by providing a player tracking card or other information identifying the player. In step 1410 a headset identifier is determined. This may comprise, for example, receiving a headset identifier from the player, from a casino employee, from the headset, or from another source. In one embodiment, determining a headset identifier may comprise determining a gaming device associated with a player and determining the headset identifier of the headset associated with the gaming device. The player identifier is associated with the headset identifier in step 1415. For example, the player identifier may be stored in a record of a database (e.g., a headset database such as the one depicted in FIG. 8 and/or a registered supplemental audio database such as the one depicted in FIGS. 9A and 9B. In another embodiment, the headset identifier may be stored on a smart card or other storage medium in association with the player identifier.

In step 1420, a type of supplemental audio preferred by the player is determined. For example, a player may provide a selection of one or more types of supplemental audio preferred by the player. In another example, the player's preference for one or more types of supplemental audio may be derived or inferred from previous choices made by the player. In step 1425, the preferred type of supplemental audio is associated with the player identifier. For example, the preferred type of supplemental audio is stored in a field of a database (e.g., registered supplemental audio database, such as the one illustrated in FIGS. 9A and 9B) as corresponding to the player identifier. In another embodiment, an indication of the preferred type of supplemental audio is stored on a smart card, in a processor of a headset or in another storage medium associated with the player identifier.

In step 1430, the payment for output of the preferred type of supplemental audio is determined. Of course, this step may be performed only in embodiments for which payment for output of the supplemental audio is required. For example, a calculation may be performed for a price to charge the player based on the number of types of supplemental audio the player has registered for, the amount of supplemental audio the player has registered for (e.g., a duration of time during which the player may access the supplemental audio), and/or other information (e.g., a status of the player). In some embodiments, the price may be determined by accessing a database and looking up a price associated with a type of supplemental audio and/or an amount of supplemental audio. In one embodiment a final price may not be determinable until after a player accesses supplemental audio. For example, music supplemental audio may have a per song or per minute cost associated therewith. Accordingly, the price for accessing the music supplemental audio may only be determinable after a player accesses the supplemental audio and it can be determined how long the player accessed the music for or how many songs the player listened to. In such embodiments, step 1430 may comprise, for example, determining a per unit (e.g., per song, per unit of time, etc.) price associated with the supplemental audio. Alternatively, in such embodiments step 1430 may be omitted.

In step 1435, an indication of payment is stored in association with the player identifier determined in step 1405. Storing an indication of payment may comprise, for example, storing an indication that a player has provided payment in exchange for supplemental audio the player has registered for. In another embodiment, storing an indication of payment may comprise storing an amount of payment a player owes for supplemental audio the player has registered for. In yet another embodiment a player may not be required to provide payment until after the player accesses the supplemental audio. In such embodiments, step 1435 may comprise, for example, storing an indication of a payment identifier (e.g., a credit card account number, a casino monetary account number, etc.) which may be used in the future to charge the player for access to supplemental audio. Alternately, step 1435 may be omitted in such embodiments.

In conclusion, while the methods and apparatus of the present invention have been described in terms of particular embodiments, those skilled in the art will recognize that the present invention may be practiced with modification and alteration without departing from the teachings disclosed herein. Some example additional embodiments are described below.

In various embodiments of the present invention, an audio output element may comprise a user device (e.g., a cellular phone, PDA, etc.). For example, in one embodiment, a gaming device 210 and/or controller 205 may be operable to determine that an audio output element comprising a cellular phone is active and/or that a player desires to hear supplemental audio via the cellular telephone and thus may output one or more types of supplemental audio to the cellular phone. Accordingly, a gaming device 210 and/or a controller 205 may comprise a means for communicating with a cellular phone of a player. In one embodiment, during a registration process, a player may provide a telephone number (e.g., 555-555-0129), such that the number may be stored in a database (e.g., in a player database and/or a registered supplemental audio database). Accordingly, in one embodiment, a gaming device 210 and/or a controller 205 may be operable to (i) determine a telephone number (e.g., access a telephone number in association with a player identifier of a player database), (ii) determine audio to be output to the telephone number (e.g., a player is entitled to supplemental audio, such as hints), (iii) dial the phone number, and (iv) output the determined audio to the telephone number. In another embodiment, a player may (i) access an interactive voice response unit or IVRU (e.g., by dialing an advertised “800” number), and (ii) enter a gaming device identifier (e.g., a numeric code indicated by a gaming device, such as “103847”), game identifier and/or player identifier. A controller (e.g., controller 205) in communication with the IVRU may then (i) determine audio to be output based on the gaming device identifier, game identifier and/or player identifier (e.g., if the player is entitled to hints, and hints are gaming device-specific and/or game-specific, a gaming device identifier and/or game identifier must be known such that relevant hints may be output), and (ii) output the audio via the IVRU, such that it may be heard by the player via the cellular phone. Thus, an audio output element may comprise a cellular phone or other user device. As described, a headset device may in some embodiments be used in conjunction with a cellular phone or other user device as is known in the art (e.g., headsets are sold in association with many commercially available brands of cellular phones).

In some embodiments, the controller 205 may receive commands from a cellular telephone or other player device and forward the commands to one or more gaming devices. For example, a player may be able to effectuate a “handle pull” or game play at a particular gaming device by pressing a button on his/her cellular telephone. For example, the controller 205 may be operable to receive a message based on the actuation of the button, interpret the message to be a request for an initiation of a game play and, in response, instruct a gaming device to initiate a game play (e.g. “server based” or “server facilitated” game play initiation).

In some embodiments, if a player provides a telephone number (e.g., a telephone number associated with a hotel room) during a headset registration process or other registration or activation process, a controller 205 and/or a gaming device 210 may be configured to route calls to a headset device. For example, a gaming device 210 and/or a controller 205 may communicate with a hotel telephone system, such that when a call is received in association with the telephone number provided by a player, a gaming device 210 and/or controller 205 may route the call such that it is output via a headset device associated with the player. In some embodiments, a player may provide a fee such that calls are routed (e.g., “call routing” is a type of supplementary audio for a which a player must register and provide a payment). In an alternate embodiment, if a player provides a cellular telephone or other contact number, calls received by the cellular telephone may be routed to a headset.

In some embodiments, a gaming device may comprise a sensor configured to determine an environmental volume level (e.g., of a portion of a casino floor). Based on the determined environmental volume level, a volume level associated with a headset may be altered. For example, an area near a gaming device may be particularly loud (e.g., greater than a certain decibel level), and thus, a volume level associated with a headset may be increased.

In one or more embodiments, a plurality of players may participate in a multiplayer casino game (e.g., a game involving a common display screen). In one example, a plurality of players may play a game comprising a common video screen on which a plurality of slot machine outcomes comprising various indicia may be determined, each outcome being associated with a particular player. Players may then share the indicia, such that a variety of payout opportunities may be created. Such a game is described in Applicant's pending application Ser. No. 10/414,934, filed Apr. 15, 2003, entitled “METHOD AND APPARATUS FOR LINKED PLAY GAMING WITH COMBINED OUTCOMES AND SHARED INDICIA,” the entirety of which is incorporated herein by reference for all purposes. In one embodiment of such a game, players may wear headsets. Accordingly, audio output to a first player may be different than audio output to a second player (e.g., if a first player receives a winning outcome and a second player receives a losing outcome, different game-related sounds may be output), which may be facilitated without confusing the individual player by outputting the sounds via the respective headsets worn by the players.

In some embodiments, a plurality of players may register as a group during a headset registration process or other process (e.g., such that a status update regarding a first player's gaming activity may be output to a second player of a group). In one or more embodiments, players registered as a group may communicate with one another using headsets. For example, as described, a headset may be configured to perform both input and output functions (e.g., a USB-based headset comprises earphones for outputting audio and a microphone such that audio may be input). Accordingly, a gaming device 210 and/or controller 205 of the present invention may be configured to (i) receive a request from a first player to communicate with a second player, and (ii) enable such communication. In one embodiment, a gaming device may be configured to output a menu via a display screen that may help a player facilitate such communication (e.g., select another player to talk to). For example, if a player presses a “Talk to My Buddies” icon of a touch-sensitive display screen, a gaming device may be configured to output a menu of group members from which the player may choose one or more to communicate with (e.g., a gaming device may determine the players identifier, access a player database which stores information about other players associated with the current player, and determine a number of “group members” in association with the player). Accordingly, a first player and a second player may communicate with one another (e.g., a controller routes the audio input/output of a first headset such that it is sent/received by a second headset). In some embodiments, such “group communication” may comprise a type of supplemental audio (e.g., players pay a fee such that they can talk to each other while in two different locations of a casino floor).

In some embodiments, if it is determined that a headset or other audio output element operating as a private audio channel is active, the output of a display device of a gaming device may be altered. For example, in one embodiment, a gaming device may comprise (i) a first display area for outputting game outcomes, and (ii) a second display area for outputting audio/video programming. In some embodiments, if a headset device is not being used or is not active, closed-captioning may appear in association with audio/video programming. Thus, in one embodiment, if a headset device is determined to be active, closed-captioning may be eliminated (e.g., because players can hear dialogue more clearly, closed-captioning may not be necessary). In other embodiments, video, icons, text and/or other graphics may be output via a display area of a gaming device in association with supplemental audio. For example, if a player is receiving supplemental audio in the form of hints, each time a hint is triggered or output, an animated character may appear on a gaming device display area, such that it appears as if the character is providing the hint (e.g., the character is animated such that it appears to talk).

In one or more embodiments, a player may receive outcomes generated by a gaming device while the device is unattended. Such systems and methods are described in Applicant's U.S. Pat. No. 6,012,983, filed Dec. 30, 1996, entitled “AUTOMATED PLAY GAMING DEVICE”; U.S. Pat. No. 6,634,942, filed Jun. 12, 2003, entitled “SYSTEM AND METHOD FOR AUTOMATED PLAY OF MULTIPLE GAMING DEVICES”; and application Ser. No. 10/635,986, filed Aug. 7, 2003, entitled “SYSTEM AND METHOD FOR REMOTE AUTOMATED PLAY OF GAMING DEVICES”; the entirety of each are incorporated herein by reference for all purposes. Accordingly, in one embodiment, a player may receive outcome data (e.g., game-related audio) associated with a gaming device via a headset, though the player may not be in proximity to the gaming device (e.g., an audio signal indicated “Bar-Bar-Bar! You won 50 credits! You now have 137 credits” may be output via a wireless headset of a player sitting in a casino restaurant).

In one or more embodiments, a player may utilize a wireless headset (e.g., a headset device is detected in proximity to a gaming device using radio-frequency identification). In one embodiment, a player leaving a gaming device (e.g., such that a transponder of a headset device leaves a field emitted by a base receiver unit) may be provided with one or more reminder messages. For example, if it is determined that a player using a headset has left the vicinity of a particular gaming device, and it is determined that a credit balance remains, the player may be output a message indicating “You forgot to cash out.” In another embodiment, if a player leaves a tracking card inserted into a card reader device, a message may indicate “You forgot your player tracking card.”

In some embodiments, a controller 205 and/or a gaming device 210 may be configured to monitor wager activity in association with a particular player. Many casino systems perform such evaluations on an ongoing basis (e.g., so as to determine a player's theoretical win”). In one embodiment, wager data may be communicated to a player. For example, a player may be alerted if wagering activity reaches a “problem gambler” status (e.g., the player has wagered more than a threshold amount during a certain period of time). In another embodiment, a reminder message may be output to a player based on wager data. For example, a player may be entitled to one or more benefits so long as a certain rate of play and/or minimum/average wager amount is maintained. Such methods are described in Applicant's U.S. Pat. No. 6,238,288, filed Dec. 31, 1997, entitled “METHOD AND APPARATUS FOR DIRECTING A GAME IN ACCORDANCE WITH SPEED OF PLAY,” the entirety of which is incorporated herein by reference for all purposes. In one example, a player may be entitled to free hints (e.g., supplementary audio) so long as the player wagers $1.50 per spin. Thus, if a player attempts to wager less than $1.50 in association with a particular game play, a message may be output (e.g., “You must wager $1.50 to receive hints”). Any and all such messages (e.g., problem gambling status message) may be output via a private audio channel such as a headset, in order to minimize embarrassment to the player or minimize the chances of another player overhearing private data being output to the player.

In some embodiments, as described, a fee may be associated with the rental of a headset. In one such embodiment, a fee may be based on a rate or amount of game play in association with one or more gaming devices (e.g., a headset may be rented for 1¢ per game play).

In one embodiment, a player cashing out a credit balance from a gaming device may be provided with a cashless gaming ticket, as is known in the art. In one embodiment, such a cashless gaming ticket may not be redeemed for cash unless a player has returned a rented headset to an appropriate location within a casino (e.g., such that players may be discouraged from stealing rented headsets).

In some embodiments, a player may provide a code when activating a headset. For example, when registering a headset, a code may be determined and provided to a player (e.g., “2836”). Thus, a player may activate and/or otherwise utilize a headset without requiring a player tracking card and yet still be identified as a player entitled to active or use the headset. For example, a gaming device 210 and/or a controller 205 may be configured to receive a code (e.g., a player enters “2836” using a keypad device of a slot machine), and determine whether or not a headset is registered in association with the code, and if so, authorize or cause audio (e.g., supplemental audio) to be output to the headset.

In some embodiments, as described, a promotional message may comprise an offer. In some embodiments, an offer may enable a player to receive a benefit (e.g., one or more free game plays, additional credits, entry into a bonus round, supplementary audio, etc.) provided the player performs or agrees to perform a particular action (e.g., participating in a survey, accepting an offer from a third party). In one example, a player may accept an offer from a third party (e.g., a player agrees to apply for a credit card), and in turn be provided with a benefit (e.g., free supplemental audio). Such methods are described in Applicant's pending U.S. application Ser. No. 10/121243, filed Apr. 11, 2002, entitled “METHODS AND SYSTEMS FOR FACILITATING GAME PLAY AT A GAMING DEVICE BY MEANS OF THIRD PARTY OFFERS,” the entirety of which is incorporated herein by reference for all purposes. In some embodiments, a benefit may be related to a particular gaming device (e.g., a player is offered a bonus “treasure chest” symbol if the player is playing a pirate-themed slot machine game). In further embodiments, an offer may be related to a particular gaming device (e.g., if a player agrees to play another 35 game plays of a particular slot machine, the player may be provided with a benefit). As described, in some embodiments a headset and/or gaming device may be equipped with a microphone such that a player may respond to an offer and/or answer survey questions aurally. In one embodiment, a player may earn a game-related benefit (e.g., free spins every X minutes) if he agrees to listen to promotional messages through a headset.

As described, a continuous stream of supplemental audio may be available for free to all casino patrons who utilize a headset. For example, in one embodiment, a player may bring a headset from home, connect the headset to a slot machine, and hear hints, instructions, music, and so on, though such supplemental audio may be unavailable to gaming device players who do not use headsets (e.g., hints, instructions and music are not output via audio speakers the sounds of which are audible to general passersby of the subject gaming device). Or, alternatively, a player may put on and/or turn on a stationary headset associated with the gaming device. Such supplemental audio may be continuous in that if a player connecting a headset device may be “tapping in” to an ongoing broadcast of audio. For example, a server may continuously output music files stored in a memory, and thus a player might connect or activate a headset mid-song.

In other embodiments, supplemental audio may be freely available to all headset users, though the audio may not be output on a continuous basis. For example, a gaming device 210 and/ or controller 205 may determine that a headset is active, and initiate an audio signal to begin in response to the determination (e.g., a player connects a headset, and a song starts from the beginning).

In some embodiments, a player may win or earn access to supplemental audio. For example, a player may achieve a slot machine outcome of “hint/hint/hint,” and thus be provided with supplemental audio in the form of a hint output to a headset. In another example, a player may be provided with music so long as the player attains one “music” symbol every minute (or, e.g., the player may attain one minute of music for each music symbol collected). It should be noted that such embodiments may motivate further play from patrons (e.g., who must “keep spinning to keep the song playing”).

In some embodiments, supplemental audio may only be available to players who meet a certain qualification. For example, supplemental audio may only be available to players who are registered hotel guests. In another example, supplemental audio may only be available to players who maintain a particular rate of play (e.g., “Keep spinning to hear music!”). Such methods are described in Applicant's U.S. Pat. No. 6,238,288, filed Dec. 31, 1997, entitled “METHOD AND APPARATUS FOR DIRECTING A GAME IN ACCORDANCE WITH SPEED OF PLAY,” the entirety of which is incorporated herein by reference for all purposes.

In some embodiments, all game related audio may be output via headphones or another private audio channel, thus eliminating the natural din of a casino. For example, instead of individual gaming devices outputting game related audio via speakers the sounds of which are audible to general passersby of a respective gaming device, the casino may output music or another type of audio via speakers located throughout the casino.

What is claimed is:

1. A method comprising:
outputting a first audio via at least one speaker of a gaming device operable to facilitate a wagering game; and
outputting the first audio and a second audio via a headset associated with the gaming device, the headset being distinct from the speaker and the second audio being distinct from the first audio.

2. The method of claim 1, further comprising:
determining that a headset associated with a gaming device is active; and
outputting the second audio via the headset upon determining that the headset is active.

3. The method of claim 1, wherein the second audio is unavailable for output via the at least one speaker, such that the second audio may only be received by a player via the headset.

4. The method of claim 1, further comprising:
determining whether the outputting of the second audio via the headset is authorized; and
only outputting the second audio via the headset if the outputting of the second audio via the headset is authorized.

5. The method of claim 4, wherein determining whether the outputting of the second audio via the headset is authorized comprises:
determining an identifier associated with a player currently playing the gaming device; and
determining, based on the identifier, whether the player qualifies for the second audio.

6. The method of claim 5, wherein the identifier associated with the player comprises at least one of an identifier of a player tracking card inserted into the gaming device and an identifier of a headset.

7. The method of claim 4, wherein determining whether the outputting of the second audio via the headset is authorized comprises:
determining whether the player has satisfied a condition for output of the second audio.

8. The method of claim 7, wherein determining whether the player has satisfied a condition for output of the second audio comprises:
determining whether the player has provided payment for at least one of the second audio and use of the headset.

9. The method of claim 7, wherein determining whether the player has satisfied a condition for output of the second audio comprises:
determining whether at least one characteristic of the player's play of the gaming device satisfies the condition.

10. The method of claim 9, wherein the at least one characteristic of the player's play of the gaming device comprises at least one of:
a speed with which the player is participating in game plays at the gaming device;
a time between game plays the player is participating in at the gaming device;
a wager per game play that the player is wagering at the gaming device;
a number of paylines the player is wagering per game play at the gaming device; and
at least one choice indicated by the player during a game play the player participated in at the gaming device.

11. The method of claim 7, wherein determining whether the player has satisfied a condition for output of the second audio comprises:
determining whether the player has previously registered for output of the second audio.

12. The method of claim 7, wherein determining whether the player has satisfied the condition for output of the second audio is performed prior to an initial output of the second audio during a play session participated in by the player at the gaming device.

13. The method of claim 7, wherein determining whether the player has satisfied the condition for output of the second audio is performed after an initial output of the second audio during a play session participated in by the player at the gaming device, the determining being performed in order to determine whether the player continues to satisfy the condition for output of the second audio.

14. The method of claim 4, wherein determining whether the outputting of the second audio is authorized comprises:
receiving an indication of whether the second audio is authorized from another processing device.

15. The method of claim 1, further comprising:
receiving payment for the second audio.

16. The method of claim 1, further comprising:
facilitating tracking of a duration for which the second audio is output.

17. The method of claim 1, further comprising:
transmitting, to another processing device, at least one indication based on which the duration can be determined.

18. The method of claim 1, wherein the first audio comprises primary audio complementing game play of the gaming device and the second audio comprises supplemental audio that is supplemental to the first audio, and further comprising:
selecting the second audio for output from a plurality of supplemental audios available for output.

19. The method of claim 18, further comprising:
receiving from the player an indication of the second audio; and
selecting the second audio based on the indication.

20. The method of claim 19, wherein the selecting is based on a selection of the second audio provided by the player prior to initiating play of the gaming device.

21. A method comprising:
outputting a first type of audio via at least one speaker of a gaming device;
determining that a headset associated with the gaming device is active;
determining, from a plurality of available types of audio that are each distinct from the first type of audio, a second type of audio to output via the headset; and
outputting the second type of audio via the headset.

22. The method of claim 21, further comprising:
outputting the first type of audio via the headset.

23. The method of claim 22, wherein the first type of audio and the second type of audio are output simultaneously such that a sound of the first type of audio may overlap with a sound of the second type of audio.

24. The method of claim 22, wherein outputting the first type of audio comprises outputting the first type of audio continuously and wherein outputting the second type of audio comprises outputting the second type of audio intermittently.

25. The method of claim 24, wherein outputting the second type of audio intermittently comprises:
determining whether an event for triggering an output of the second type of audio has occurred, and outputting the second type of audio upon determining that the even has occurred.

26. The method of claim 21, wherein determining the second type of audio comprises:
determining an identifier of a player associated with at least one of current play of the gaming device and the headset; and
determining the second type of audio based on the player identifier.

27. The method of claim 26, wherein determining the second type of audio based on the player identifier comprises:
determining a second type of audio that the player has registered for.

28. The method of claim 21, wherein determining the second type of audio based on the player identifier comprises:
determining at least one preference associated with the player; and
determining the second type of audio based on the preference.

29. The method of claim 26, wherein determining the second type of audio based on the player identifier comprises:
determining at least one characteristic associated with current play of the gaming device; and
determining the second type of audio based on the at least one characteristic.

30. The method of claim 29, wherein the at least one characteristic comprises at least one of:
a current time;
a denomination of the gaming device;
a type of the gaming device;
a game playable on the gaming device;
a skill level of the player;
an experience level of the player;
a manufacturer of the gaming device;
a benefit previously earned by the player; and
a level of activity.

31. The method of claim 30, wherein the level of activity comprises at least one of:
a level of activity of the gaming device;
a level of activity associated with the player; and
a level of activity of at least an area of a casino in which the gaming device is located.

32. A gaming device, comprising:
a processor operable to facilitate a wagering game; and
a memory, the memory storing a program for directing the gaming device to perform at least one function;
at least one speaker controlled by the processor;
wherein the processor further operable with the program to:
output a first audio via the at least one speaker; and
output a second audio that is distinct from the first audio via a headset associated with the gaming device.

33. The gaming device of claim 32, wherein the first audio comprises game related audio that is audible to all players within a vicinity of the gaming device; and
wherein the second audio comprises private audio that is only audible to a player listening to the second audio via the headset.

34. The gaming device of claim 32, wherein the processor is further operable with the program to:
determine whether the headset is active; and
only output the second audio via the headset if the headset is active.

35. The gaming device of claim 32, wherein the processor is further operable with the program to:
determine whether a player currently playing the gaming device qualifies to receive the output of the second audio via the headset; and
only output the second audio via the headset if the player qualifies.

36. The gaming device of claim 35, wherein the processor being operable with the program to determine whether the player qualifies to receive the output of the second audio comprises determining at least one of:
determining whether the player has previously completed a registration process associated with the second audio;
determining whether the player has prepaid for the second audio;
determining whether the player has provided a means for charging the player for the second audio; and
determining whether a manner in which the player is playing the gaming device satisfies at least one criteria for outputting the second audio.

37. A device, comprising:
a processor; and
a memory, the memory storing a program for directing the device to perform a plurality of functions, the processor being operable with the program to:
cause audio to be output via a gaming device that is operable to facilitate a wagering game;
determine that a headset associated with the gaming device is active; and
cause, based on the determination that the headset is active, the output of the audio being output via the gaming device to be altered.

38. The device of claim 37, wherein the device comprises the gaming device.

39. The gaming device of claim 37, wherein the processor being operable with the program to alter the output of the audio comprises:
outputting supplementary audio via the headset, the supplementary audio being supplementary to primary audio being output via at least one speaker of the gaming device that is distinct from the headset.

40. The method of claim 39, wherein both the primary audio and the supplementary audio is output via the headset.

41. The gaming device of claim 37, wherein the processor being operable with the program to alter the output of the audio comprises:
the processor being operable with the program to adjust an audio parameter.

42. The gaming device of claim 37, wherein the processor being operable with the program to alter the output of the audio comprises:
alter the output of the audio content based on at least one preference associated with a player currently playing the gaming device.
